(19) United States
(12) Patent Application Publication
(10) Pub. No.: US 2017/0031490 A1
(43) Pub. Date: Feb. 2, 2017

(54) TOUCH SENSOR ELECTRODE, TOUCH PANEL AND DISPLAY DEVICE

(71) Applicant: TOPPAN PRINTING CO., LTD., Taito-ku (JP)

(72) Inventors: Yasunori HASHIDA, Taito-ku (JP); Takahiro HARADA, Taito-ku (JP); Kanae BANI, Taito-ku (JP)

(73) Assignee: TOPPAN PRINTING CO., LTD., Taito-ku (JP)

(21) Appl. No.: 15/294,837

(22) Filed: Oct. 17, 2016

Related U.S. Application Data
(63) Continuation of application No. PCT/JP2014/083435, filed on Dec. 17, 2014.

(30) Foreign Application Priority Data
Apr. 15, 2014 (JP) 2014-083433
Jun. 2, 2014 (JP) 2014-114460

(51) Int. Cl. G06F 3/041; G02F 1/1362; G02F 1/1343; G06F 3/044; G02F 1/1333

(52) U.S. Cl. CPC G06F 3/0412; G06F 3/044; G06F 3/0416; G02F 1/13338; G02F 1/134309; G02F 1/13439; G02F 1/136286; G06F 2203/04103; G06F 2203/04111; G02F 1/133514

(57) ABSTRACT

A touch sensor electrode includes first electrodes arrayed in a first direction on a first surface of a substrate and each extending along a second direction perpendicular to the first direction, and second electrodes arrayed in the second direction on a second surface of the substrate and each extending along the first direction. Each one of the first and second electrodes includes reference pattern elements, each having a main line and a sub-line and forming a pattern with reference to a reference direction, which is the first direction for the first electrodes and the second direction for the second electrodes, respectively. The first and second electrodes are formed such that the reference pattern elements of the first and second electrodes together form lattice pattern in plan view perpendicular to the substrate, and that the lattice pattern includes square lattice units where each side has a same length as the sub-line.

### CROSS-REFERENCE TO RELATED APPLICATIONS

The present application is a continuation of International Application No. PCT/JP2014/083435, filed Dec. 17, 2014, which is based upon and claims the benefits of priority to Japanese Application No. 2014-083433, filed Apr. 15, 2014, and claims the benefits of priority to Japanese Application No. 2014-114460, filed Jun. 2, 2014. The entire contents of these applications are incorporated herein by reference.

### BACKGROUND OF THE INVENTION

Field of the Invention

The present invention relates to a touch sensor provided with a plurality of electrodes arranged in one direction, a touch panel and a display device.

Discussion of the Background

A touch sensor provided with a display device has a drive electrode and a sensing electrode which are examples of touch sensor electrodes. In the touch sensor, a finger and the like touching the control surface of the display device is detected as a change in the electrostatic capacitance between the drive electrode and the sensing electrode. Images formed on the display panel of the display device are outputted to the control surface through the drive electrode and the sensing electrode. Therefore, the drive electrode and the sensing electrode are each configured, for example, by a group of a plurality of linear electrode lines arranged spaced apart from one another. (For example, see JP-A 2012-079238)

The electrode lines of the drive electrode and those of the sensing electrode form a square grid pattern, when viewed in the direction in which the drive electrode and the sensing electrode are stacked. On the other hand, the display panel has a plurality of pixels arranged in a matrix pattern along the direction in which the drive electrode is arranged and the direction in which the sensing electrode in is arranged. The plurality of pixels are defined by a black matrix having a square grid pattern. Therefore, Moiré is produced in the display device in conformity with the square grid pattern forming the touch sensor electrode and the square grid pattern forming the black matrix. As a result, the qu109ality of the image outputted to the control surface decreases. Moiré mentioned above is not limited to the combination of the square grid pattern forming a touch sensor electrode with the square grid pattern forming the black matrix, but can be commonly produced by a combination of, for example, a repeating pattern such as a plurality of line patterns with a grid pattern forming a touch sensor electrode.

### SUMMARY OF THE INVENTION

According to one aspect of the present invention, a touch sensor electrode includes a transparent dielectric substrate having a first surface and a second surface opposite to the first surface, first electrodes arrayed in a first direction on the first surface and each extending along a second direction perpendicular to the first direction, and second electrodes arrayed in the second direction on the second surface and each extending along the first direction. Each one of the first electrodes and each one of the second electrodes include reference pattern elements, each of the reference pattern elements has a main line and a sub-line and forms a pattern with reference to a reference direction, which is the first direction for the first electrodes and the second direction for the second electrodes, respectively, the main line extends linearly from a first main endpoint to a second main endpoint in a main line direction that forms an angle in a range of from 58° to 68° relative to the reference direction, the sub-line extends linearly from the second main endpoint to a sub-endpoint in a direction perpendicular to the main line and has a length half of the main line, where the sub-endpoint is the first main endpoint of another reference pattern element located in the main line direction with relative to the sub-line, and the first and second electrodes are formed such that the reference pattern elements of the first and second electrodes together form a lattice pattern in plan view perpendicular to the transparent dielectric substrate, and that the lattice pattern include a plurality of lattice units each in a square shape where each side has a same length as the sub-line.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a plan view illustrating a planar structure of a display device according to a first embodiment that embodies the present invention, i.e. a view in which components different from one another are partially illustrated by being cut in order of layering.

FIG. 2 is a cross-sectional view illustrating a cross sectional structure of the display device of FIG. 1.

FIG. 3 is a block diagram illustrating an electrical configuration of a touch panel of the display device of FIG. 1.

FIG. 4 is a plan view illustrating an arrangement of drive electrode lines of the display device of FIG. 1.

FIG. 5 is a partially enlarged view showing, at an enlarged scale, an area A encompassed by the dash-dot-dot lines of FIG. 4.

FIG. 6 is a partially enlarged view showing, at an enlarged scale, an area B encompassed by the dash-dot-dot lines of FIG. 4.

FIG. 7 is a plan view illustrating a relationship between the arrangement of drive electrode lines and the arrangement of sensing electrode lines of the display device of FIG. 1.

FIG. 8 is a partially enlarged view showing, at an enlarged scale, a part of a drive electrode in a modification of the first embodiment.

FIG. 9 is a plan view illustrating a relationship between the arrangement of drive electrode lines and the arrangement of sensing electrode lines in the modification of FIG. 8.

FIG. 10 is a plan view illustrating a planar structure of a display device in a second embodiment that embodies the present invention, i.e. a view in which components different from one another are partially illustrated by being cut in order of layering.

FIG. 11 is a plan view illustrating a disposition of drive electrode lines of the display device of FIG. 10.

FIG. 12 is a plan view illustrating a relationship between the arrangement of the drive electrode lines and the arrangement of sensing electrode lines of the display device of FIG. 10.

FIG. 13 is a view illustrating the operation of the display device of FIG. 10.

FIG. 14 is a view illustrating the operation of the display device of FIG. 1.

FIG. 15 is a plan view illustrating the arrangement of drive electrode lines in a modification of the second embodiment.

FIG. 16 is a plan view illustrating a relationship between the arrangement of the drive electrode lines and the arrangement of sensing electrode lines in the modification of FIG. 15.

FIG. 17 is a cross-sectional view illustrating a cross sectional structure of a display device in another modification.

FIG. 18 is a cross-sectional view illustrating a cross sectional structure of a display device in a still another modification.

FIG. 19 is a partially enlarged view showing, at an enlarged scale, a part of a drive electrode in a first modification.

FIG. 20 is a partially enlarged view showing, at an enlarged scale, a portion where a part of the drive electrode overlaps with a part of a sensing electrode in the first modification of FIG. 19.

FIG. 21 is a partially enlarged view showing, at an enlarged scale, a portion where a reference pattern element of a drive electrode overlaps with a reference pattern element of a sensing electrode in a second modification, i.e. a view illustrating candidates of positions of auxiliary lines.

FIG. 22 is a partially enlarged view showing, at an enlarged scale, a part of a drive electrode together with a dummy part in a third modification.

FIG. 23 is a partially enlarged view showing, at an enlarged scale, a drive detection unit together with the dummy part in the third modification of FIG. 22.

FIG. 24 is a partially enlarged view showing, at an enlarged scale, a portion where a part of the drive electrode overlaps with a part of the sensing electrode in the third modification of FIG. 22.

FIG. 25 is a partially enlarged view showing, at an enlarged scale, a part of a drive electrode in a fourth modification.

FIG. 26 is a partially enlarged view showing, at an enlarged scale, a portion where a part of the drive electrode overlaps with a part of a sensing electrode in the fourth modification of FIG. 25.

FIG. 27 is a partially enlarged view showing, at an enlarged scale, a part of a drive electrode in a fifth modification.

FIG. 28 is a partially enlarged view showing, at an enlarged scale, a part of the drive electrode in the fifth modification of FIG. 27, i.e. a view illustrating positions of starting point pattern elements.

FIG. 29 is a partially enlarged view showing, at an enlarged scale, a part of a sensing electrode in the fifth modification of FIG. 27.

FIG. 30 is a partially enlarged view showing, at an enlarged scale, a portion where a part of the drive electrode overlaps with a part of the sensing electrode in the fifth modification of FIG. 27.

### DESCRIPTION OF THE EMBODIMENTS

The embodiments will now be described with reference to the accompanying drawings, wherein like reference numerals designate corresponding or identical elements throughout the various drawings.

### First Embodiment

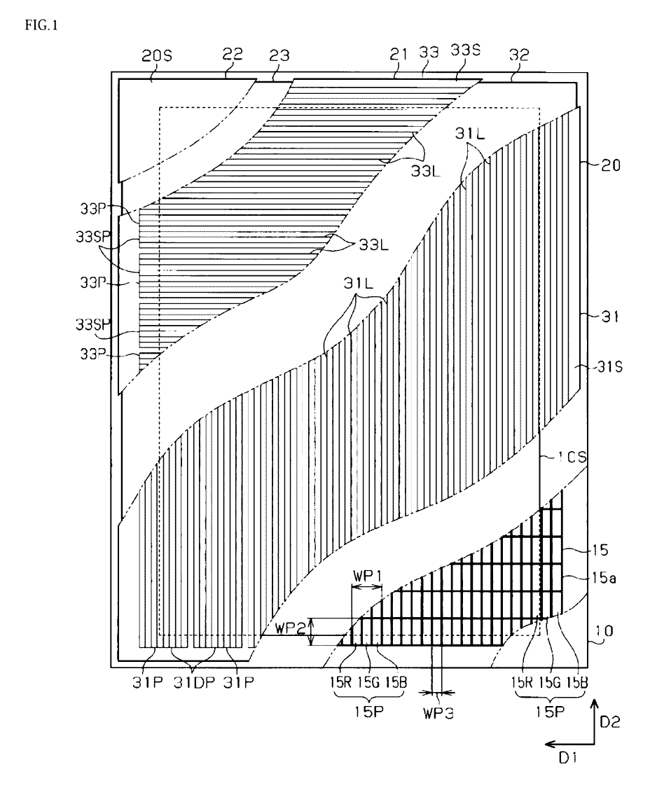

With reference to FIGS. 1 to 7, a first embodiment that embodies a touch sensor electrode, a touch panel and a display device will be described. The following description sequentially addresses the configuration of the display device, the electrical configuration of the touch panel, the configuration of the drive electrode, the configuration of the touch sensor electrode, and the advantageous effects of the touch sensor electrode.

### <Display Device>

With reference to FIG. 1, a configuration of the display device will be described. In FIG. 1, the color filter layer, the drive electrode, and the sensing electrode are illustrated in an exaggerated manner, for convenience of describing the configurations of a color filter layer provided to the display device, the drive electrode formed on the drive surface, and the sensing electrode formed on the sensing surface. Further, FIG. 1 schematically shows drive electrode lines provided to the drive electrode, and sensing electrode lines provided to the sensing electrode.

As shown in FIG. 1, the display device is a laminate in which, for example, a display panel 10 as a liquid crystal panel is bonded to a touch panel 20 via a transparent adhesive layer. The display device is provided with a drive circuit which drives the touch panel 20. A display surface 10S in a rectangular shape is defined in the surface of the display panel 10, and the information such as images based on external image data is displayed on the display surface 10S. When the relative arrangement between the display panel 10 and the touch panel 20 is ensured to be fixed using another configuration, such as a housing, the transparent adhesive layer may be omitted.

The display panel 10 is provided with a color filter layer 15, wherein a black matrix 15a is in a lattice pattern configured by a plurality of lattice units arrayed along a first direction D1 that is one direction and a second direction D2 perpendicular to the first direction D1. Any one of a red color layer 15R for displaying a red color, a green color layer 15G for displaying a green color, and a blue color layer 15B for displaying a blue color is disposed in an area defined by each lattice unit which configures the black matrices 15a.

For example, each of the plurality of red color layers 15R, the plurality of green color layers 15G, and the plurality of blue color layers 15B in the color filter layer 15 are arrayed along the second direction D2.

One pixel 15P includes one red color layer 15R, one green color layer 15G, and one blue color layer 15B. A plurality of pixels 15P are arranged along the first direction D1 in a state of maintaining the arrangement order of the red color layer 15R, the green color layer 15G, and the blue color layer 15B in the first direction D1. The width along the first direction D1 in each pixel 15P is a first pixel width WP1, and the width along the second direction D2 is a second pixel width WP2, and the width along the first direction D1 in each color layer is a third pixel width WP3. Each of the first pixel width WP1, the second pixel width WP2, and, the third pixel width WP3 is set to a value according to the resolution and the like of the display device.

The touch panel 20 is an electrostatic capacitance type touch panel that is a laminate in which a touch sensor electrode 21 is bonded to a cover layer 22 by a transparent adhesive layer 23. The touch panel 20 allows the information to be displayed on the display panel 10 to pass therethrough. The cover layer 22 is formed of a glass substrate, a resin film or the like. A surface of the cover layer 22, which is opposite to that contacting the transparent adhesive layer 23, functions as a control surface 20S of the touch panel 20. The transparent adhesive layer 23 has optical transparency for allowing the image displayed on the display surface 10S to pass therethrough. For example, a polyether adhesive agent or an acrylic adhesive agent is used for the transparent adhesive layer 23.

A transparent substrate 31 which is a component of the touch sensor electrode 21 overlaps the entirety of the display surface 10S formed in the display panel 10 to transmit the image displayed on the display surface 10S. The transparent substrate 31 is formed of, for example, a base material such as a transparent glass substrate or a transparent resin film, and may have a single-layer structure formed of one base material, or may have a multilayer structure where two or more base materials are layered.

A surface of the transparent substrate 31, which is opposite to that contacting the display panel 10, is permitted to serve as a drive surface 31S. A plurality of drive electrodes 31DP are arranged along the first direction D1 in the drive surface 31S of the transparent substrate 31. Each of the plurality of drive electrodes 31DP extends along the second direction D2 which is perpendicular to the first direction D1. Each drive electrode 31DP is provided with a pad 31P disposed at an end in the second direction D2, and a plurality of drive electrode lines 31L extending along the second direction D2. The plurality of drive electrode lines 31L are connected to the pad 31P at the end in the second direction D2.

Each drive electrode line 31L is made up of a plurality of reference pattern elements having a pattern which is defined based on the first direction D1 as a reference direction that is defined in the drive electrode 31DP. The drive electrode 31DP is an example of the first electrode.

Forming materials that can be used for the drive electrodes 31DP include a metal film such as of copper or aluminum, a metal oxide film such as of zinc oxide, and a complex oxide film such as of indium tin oxide or indium gallium zinc oxide. The complex oxide film includes a metal oxide such as of indium, tin, gallium and zinc, or the like. Further, a silver nanowire, an electrically conductive polymer film, or an electrically conductive film such as a graphene film can be used for the forming material of the drive electrodes 31DP.

Each of the drive electrodes 31DP is separately connected to a selection circuit. By receiving a drive signal supplied by the selection circuit, a corresponding one of the drive electrodes DP is selected by the selection circuit.

The drive surface 31S and the plurality of drive electrodes 31DP are bonded to a transparent dielectric substrate 33 by a transparent adhesive layer 32. The transparent adhesive layer 32 has optical transparency for allowing the image displayed on the display surface 10S to pass therethrough, and adheres the drive surface 31S and the plurality of drive electrodes 31DP with the transparent dielectric substrate 33. For example, a polyether adhesive agent or an acrylic adhesive agent is used for the transparent adhesive layer 32. The transparent adhesive layer 32 and the transparent dielectric substrate 33 configure a dielectric substrate whose back surface is formed with the plurality of drive electrodes 31DP.

The transparent dielectric substrate 33 is, for example, made of a base material such as a transparent resin film which is made such as of polyethylene terephthalate, or a transparent glass substrate, and may have a single-layer structure formed of one substrate, or may have a multilayer structure where two or more substrates are layered. The transparent dielectric substrate 33 has optical transparency for allowing the image displayed on the display surface 10S to pass therethrough and relative permittivity suitable for detecting the electrical capacitance between electrodes.

A surface of the transparent dielectric substrate 33, which is opposite to that contacting the transparent adhesive layer 32, is permitted to serve as a sensing surface 33S. On the sensing surface 33S of the transparent dielectric substrate 33, a plurality of sensing electrodes 33SP are arrayed along the second direction D2. Each of the plurality of sensing electrodes 33SP extends along the first direction D1 perpendicular to the second direction D2. Each sensing electrode 33SP is provided with a pad 33P disposed on an end in the first direction D1, and a plurality of sensing electrode lines 33L extending along the first direction D1. The plurality of drive electrode lines 33L are connected to the pad 33P at the end in the second direction D2.

Each sensing electrode line 33L is made up of a plurality of reference pattern elements having a pattern which is defined based on the second direction D2 as a reference direction that is defined in the sensing electrode 33SP. The sensing electrode 33SP is an example of the second electrode.

Similarly to the aforementioned drive electrode 31D, forming materials that can be used for the sensing electrodes 335P include a metal film such as of copper or aluminum, a metal oxide film such as of zinc oxide, and a complex oxide film such as of indium tin oxide or indium gallium zinc oxide. The complex oxide film includes a metal oxide such as of indium, tin, gallium and zinc, or the like. Further, a silver nanowire, an electrically conductive polymer film, or an electrically conductive film such as a graphene film can be used for the forming material of the sensing electrodes 33SP.

Each of the sensing electrodes 33SP is separately connected to the detection circuit, so that the voltage of the sensing electrode 33SP is detected by the detection circuit. The touch sensor electrode 21, the selection circuit, and, the detection circuit are one example of the touch sensor.

The sensing surface 33S and the plurality of sensing electrodes 33SP are bonded together to the cover layer 22 by the aforementioned transparent adhesive layer 23.

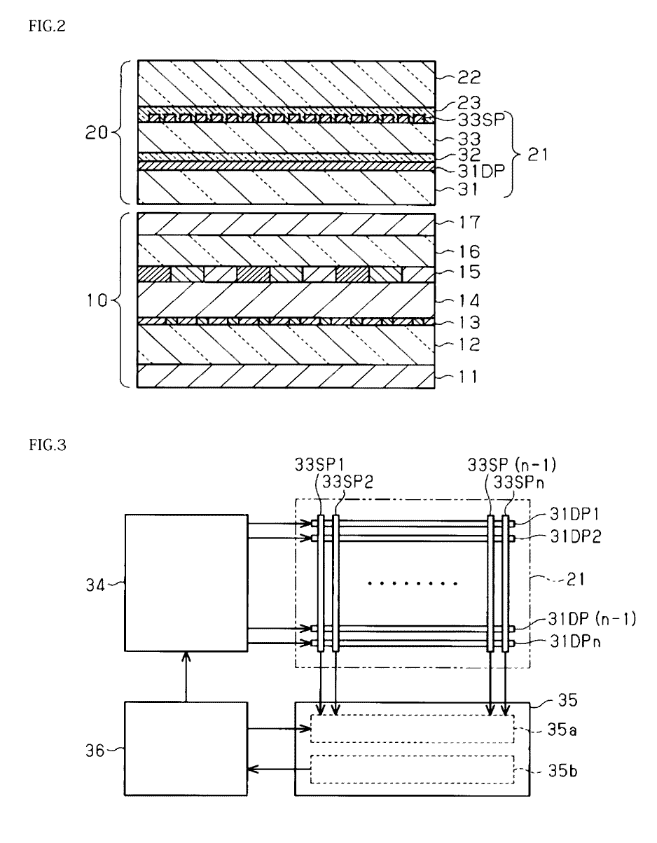

As shown in FIG. 2, the transparent substrate 31, the drive electrode 31DP, the transparent adhesive layer 32, the transparent dielectric substrate 33, the sensing electrode 33SP, the transparent adhesive layer 23 and the cover layer 22 are disposed in the touch panel 20, in order from the component closest to the display panel 10. Of these, the transparent dielectric substrate 33 is sandwiched between the plurality of drive electrodes 31DP and the plurality of sensing electrodes 33SP.

The transparent adhesive layer 32 is disposed between the drive electrode 31DP and the transparent dielectric substrate 33, while covering the periphery of the drive electrode lines 31L as the components of the drive electrode 31DP and filling between the adjacent drive electrode lines 31L. Further, the transparent adhesive layer 23 is disposed between the sensing electrode 33SP and the cover layer 22, while covering the periphery of the sensing electrode lines 33L as the components of the sensing electrode 33SP and filling between the adjacent sensing electrode lines 33L. Of these components, at least one of the transparent adhesive layer 23 and the transparent substrate 31 may be omitted.

Further, the plurality of components of the display panel 10 are arranged as follows in the display panel 10, in order of the component furthest from the touch panel 20. That is, in order of the component furthest from the touch panel 20, a lower polarizer 11, a thin film transistor (hereinafter referred to as a TFT) substrate 12, a TFT layer 13, a liquid crystal layer 14, a color filter layer 15, a color filter substrate 16 and an upper polarizer 17 are disposed. Of these, the TFT layer 13 is provided therein with pixel electrodes forming subpixels in a matrix pattern. Moreover, in the color filter layer 15, the black matrix 15a defines a plurality of areas each having a square shape facing corresponding one of the subpixels. In each area defined by the black matrix 15a, the aforementioned color layer which changes white light to light of any one of red, green and blue colors is disposed.

The display panel 10 does not have to be a liquid crystal panel, and may be, for example, an organic EL panel, or the like.

In the configuration which omits the transparent adhesive layer 23, the surface of the cover layer 22, which faces the transparent dielectric substrate 33, may be set as the sensing surface 33S, and the plurality of sensing electrodes 33SP may be formed by patterning one thin film formed on the sensing surface 33S.

Further, when fabricating the touch panel 20, a method for sticking the touch sensor electrode 21 together with the cover layer 22 by the transparent adhesive layer 23 may be adopted, or the following fabrication methods may be adopted as a method different from the previous method. That is, a thin film layer made of a conductive metal such as copper can be formed directly or through an underlayer on a cover layer 22 such as of a resin film, and a resist layer in a pattern of the sensing electrode can be formed on the thin film layer. Subsequently, the thin film layer can be processed into the plurality of sensing electrodes 33SP by wet etching using ferric chloride or the like, thereby obtaining the first film. Further, in the same manner as the sensing electrode 33SP, the thin film layer formed on another resin film can be processed into the plurality of drive electrodes 31DP, thereby obtaining the second film. Then, the first and second films are bonded to the transparent dielectric substrate 33 by a transparent adhesive layer to sandwich the transparent dielectric substrate 33.

### <Electrical Configuration of Touch Panel>

With reference to FIG. 3, the electrical configuration of the touch panel 20 will be described. An electrical configuration of a mutual-capacitance type touch panel 20 will be described below as an example of the electrostatic capacitance type touch panel 20.

As shown in FIG. 3, the touch panel 20 includes a selection circuit 34, a detection circuit 35, and a control unit 36. The selection circuit 34 can be connected to the plurality of drive electrodes 31DP, the detection circuit 35 can be connected to the plurality of sensing electrodes 33SP, and the control unit 36 is connected to the selection circuit 34 and the detection circuit 35.

The control unit 36 generates and outputs a start timing signal for the selection circuit 34 to start generation of a drive signal for each drive electrode 31DP. The control unit 36 generates and outputs a scan timing signal which causes the selection circuit 34 to serially scan targets to which the drive signal is supplied from a first drive electrode 31DP to an n-th drive electrode 31DP.

On the one hand, the control unit 36 generates and outputs a start timing signal which causes the detection circuit 35 to start detecting the current passing through each sensing electrode 33SP. The control unit 36 generates and outputs a scan timing signal which causes the detection circuit 35 to serially scan targets to be detected from a first sensing electrode 33SP to an n-th sensing electrode 33SP.

The selection circuit 34 starts generating the drive signal on the basis of the start timing signal which the control unit 36 has outputted, and scans the output targets of the drive signal from a first drive electrode 31DP1 to an n-th drive electrode 31DPn on the basis of the scan timing signal which the control unit 36 has outputted.

The detection circuit 35 includes a signal acquiring unit 35a and a signal processing unit 35b. The signal acquiring unit 35a starts acquiring a current signal which is an analog signal generated at each sensing electrode 33SP on the basis of the start timing signal which the control unit 36 has outputted. Then, the signal acquiring unit 35a scans acquisition targets of the electric current signal from a first sensing electrode 33SP1 to an n-th sensing electrode 33SPn outputted from the control unit 36.

The signal processing section 35b processes each current signal which the signal acquiring section 35a has acquired, generates a voltage signal which is a digital value, and outputs the generated voltage signal to the control section 36. Thus, a change in the electrostatic capacitance between the drive electrode 31DP and the sensing electrode 33SP is measured by the selection circuit 34 and the detection circuit 35 by generating a voltage signal from an electric current signal which changes depending on the change in the electrostatic capacitance. The selection circuit 34 and the detection circuit 35 are an example of the peripheral circuit.

The control unit 36 detects the position on the touch panel 20 touched by a user's finger on the basis of the voltage signal which the signal processing unit 35b has outputted.

The touch panel 20 is not limited to the aforementioned mutual-capacitance type touch panel 20, and may be a self-capacitance type touch panel.

<Drive Electrode>

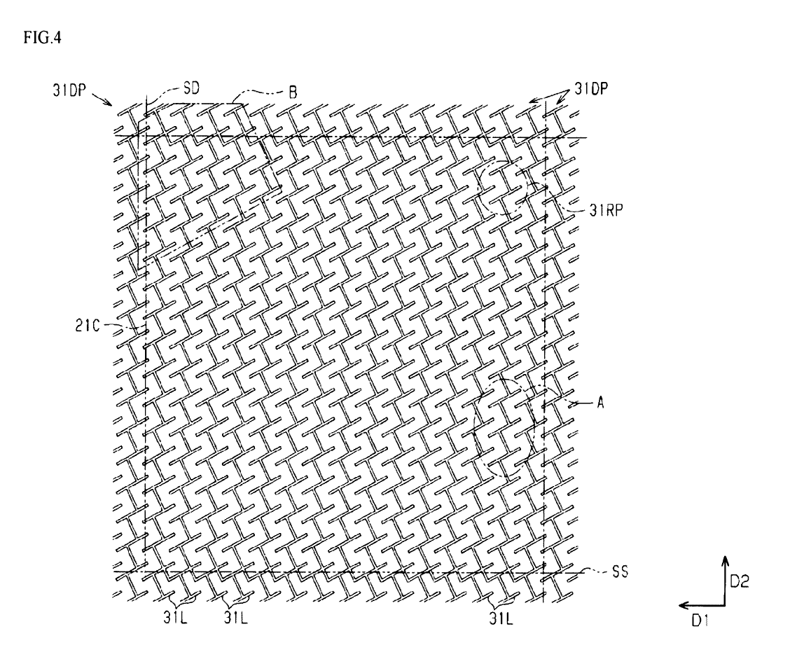

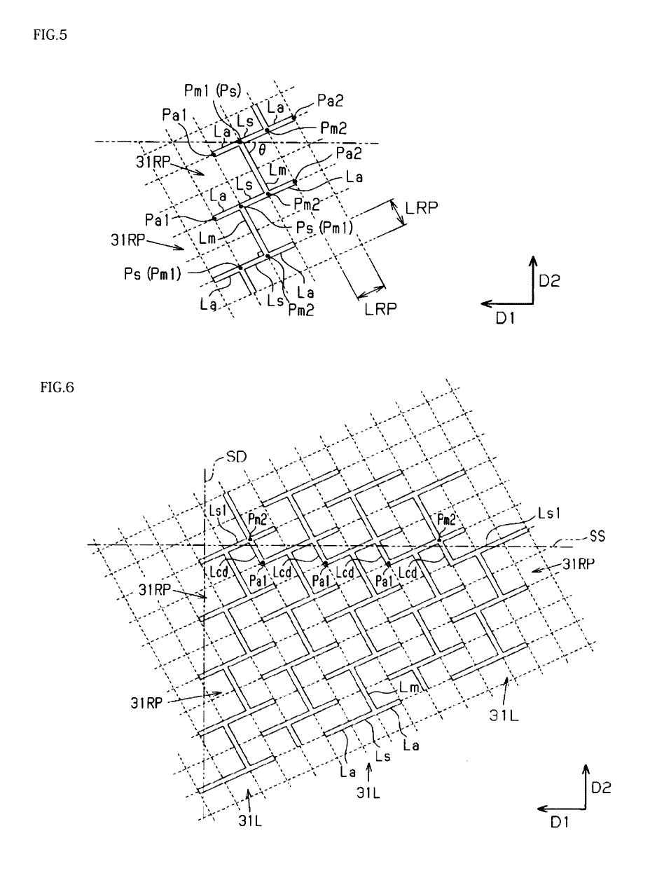

With reference to FIGS. 4 to 6, a configuration of the drive electrode 31DP will be described. FIG. 4 is a plan view showing a planar structure of a portion of the drive electrode 31DP. In FIG. 4, for the sake of convenience of describing the arrangement of the plurality of drive electrode lines of the drive electrode 31DP, the width of the drive electrode line is illustrated in an exaggerated manner. While the sensing electrode 33SP is different form the drive electrode 31DP in that the reference direction of the reference pattern element is in the second direction D2, the configuration of the reference pattern element of sensing electrode 33SP is equal to that of the drive electrode 31DP. Therefore, the configuration of the drive electrode 31DP is described in detail below, and a detailed description regarding the configuration of the sensing electrode 33SP is omitted.

As shown in FIG. 4, each drive electrode 31DP has a plurality of, e.g. fifteen, drive electrode lines 31L arrayed along the first direction D1. Each drive electrode line 31L is made up of a plurality of reference pattern elements 31RP arrayed along the second direction D2. The space between two drive electrode lines 31L adjacent in the first direction D1 is constant whether the space is present inside a drive electrode 31DP or is present between two drive electrodes 31DP adjacent in the first direction D1.

However, while two electrode lines 31L adjacent in the first direction D1 in the fifteen drive electrode lines 31L configuring the drive electrode 31DP are electrically connected to each other, two drive electrodes 31DP adjacent in the first direction D1 are not electrically connected to each other.

Among the dash-dot-dot lines shown in FIG. 4, the straight ones extending along the second direction D2 are each disposed between two drive electrodes 31DP adjacent in the first direction D1. The area sandwiched between two dash-dot-dot lines extending along the second direction D2 and adjacent to each other in the first direction D1 represents a drive electrode line area SD that is a range occupied by the drive electrode 31DP. However, among the dash-dot-dot lines shown in FIG. 4, the straight ones extending along the first direction D1 are each disposed between two sensing electrodes 33SP adjacent in the second direction D2. The area sandwiched between two dash-dot-dot lines extending along the first direction D1 and adjacent to each other in the second direction D2 represents a sensing electrode line area SS that is a range occupied by the sensing electrode 33SP.

One drive electrode 31DP, when viewed from a direction perpendicular to the transparent dielectric substrate 33, intersects three-dimensionally with a plurality of sensing electrodes 33SP, while the drive electrode line area SD of one drive electrode 31DP intersects three-dimensionally with a plurality of sensing electrode line areas SS. In other words, in plan view seen from a direction perpendicular to the transparent dielectric substrate 33, the drive electrodes 31DP and the sensing electrodes 33SP are three-dimensionally arranged so that one drive electrode 31DP intersects with each of the plurality of sensing electrodes 33SP. Moreover, a region where a drive electrode line area SD intersects three-dimensionally with a sensing electrode line area SS forms a cell 21C. In other words, one cell corresponds to an area where one drive electrode line area SD intersects and overlaps with one sensing electrode line area SS in plan view seen perpendicular to the transparent dielectric substrate 33. Each cell 21C serves as a unit for specifying an initial value of the electrostatic capacitance in the touch sensor electrode 21, and a change of the electrostatic capacitance by contact such as by the finger of a human.

Thus, the plurality of cells 21C in each drive electrode 31DP are arranged along the second direction D2, and the plurality of cells 21C in each sensing electrode 33SP are arranged along the first direction D1.

FIG. 5 is a partially enlarged view showing, at an enlarged scale, a part of area A encompassed by the dash-dot-dot lines of FIG. 4. In FIG. 5, for convenience of describing the arrangement of the electrode lines of the reference pattern element 31RP, the width of the electrode lines is illustrated in an exaggerated manner.

As shown in FIG. 5, the reference pattern element 31RP is made up of one main line Lm, one sub-line Ls, and two auxiliary lines La. The main line Lm has a linear shape and forms a main line angle θ, that is a predetermined angle, relative to the first direction D1 that is the reference direction in the drive electrode 31DP. The main line Lm extends from a first main endpoint Pm1 to a second main endpoint Pm2. The main line angle θ is a predetermined angle which is in the range of not less than 58° to not more than 68°, and preferably is 63.435°. The direction forming the main line angle θ relative to the first direction D1 is the main line direction.

The sub-line Ls has a linear shape extending from the second main endpoint Pm2 to a sub-endpoint Ps along a direction perpendicular to the main line Lm. The length of the sub-line Ls is half the length of the main line Lm. When the sub-line Ls has a length corresponding to a unit length LRP, the length of the main line Lm is 2LRP. The sub-endpoint Ps corresponds to the first main endpoint Pm1 of another reference pattern element 31RP disposed in the main line direction of the sub-line Ls, with respect to the sub-line Ls having the sub-endpoint Ps.

Each of the auxiliary lines La has a linear shape extending along the direction in which the sub-line Ls extends, and has the same length as the sub-line Ls. In short, the length of the auxiliary line La is the unit length LRP. Of the two auxiliary lines La, one extends from the second main endpoint Pm2 to a second auxiliary endpoint Pa2, and the other auxiliary line La extends from the sub-endpoint Ps to a first auxiliary endpoint Pa1.

The width of each of the main lines Lm, the sub-lines Ls, and the auxiliary lines La is, for example, in the range of 0.1 μm or more to 12 μm or less.

Each reference pattern element 31RP is in a shape conforming to a part of a square lattice with a side whose length is equal to the sub-line Ls of the unit length LRP. That is, each reference pattern element 31RP is in a shape conforming to each square of a two-dimensional square lattice, in which the main line Lm configures a side extending along the main line direction, and the sub-line Ls and the auxiliary lines La configure a side extending perpendicular to the main line Lm. The two-dimensional square lattice has a pattern in which squares, each being a lattice unit, continue two-dimensionally. When the plurality of drive electrodes 31DP overlap three-dimensionally with the plurality of sensing electrodes 33SP sandwiching the transparent dielectric substrate 33 therebetween, the first main endpoint Pm1, the second main endpoint P1112, the sub-endpoint Ps, the first auxiliary endpoint Pa1, and the second auxiliary endpoint Pa2 are positioned at the lattice points of the square lattice. Therefore, while the reference pattern element 31RP of the drive electrode 31DP and the reference pattern element of the sensing electrode 33SP have points of intersection, i.e., overlapped points, they do not have line segments configuring the same sides in the square lattice.

FIG. 6 is a partially enlarged view showing, at an enlarged scale, a part of area B encompassed by the dash-dot-dot lines of FIG. 4. In FIG. 6, for convenience of describing the arrangement of the drive electrode lines 31L, the width of the electrode lines is illustrated in an exaggerated manner.

As shown in FIG. 6, each drive electrode line 31L included in a drive electrode 31DP is made up of a plurality of reference pattern elements 31RP arranged along the second direction D2, and a plurality of drive electrode lines 31L are arranged along the first direction D1. In each drive electrode line 31L, the sub-line Ls included in one reference pattern element 31RP is an intersection sub-line Ls1 which intersects with the straight line defining one sensing electrode line area SS. The drive electrode 31DP further includes a drive connection line Lcd having the same length as the sub-line Ls and extending from the second main endpoint Pm2 along the main line direction.

The drive connection line Lcd electrically connects two drive electrode lines 31L disposed inside one cell 21C with each other. The drive connection line Lcd extends from the second main endpoint Pm2 to the first auxiliary endpoint Pa1 of one reference pattern element 31RP in the drive electrode line 31L adjacently located in the first direction D1. The drive connection line Lcd overlaps with a part of the reference pattern element 33RP forming one sensing electrode 33SP, in plan view perpendicular to the transparent dielectric substrate 33. Alternatively, the drive connection line Lcd does not in have to overlap with a part of the reference pattern element 33RP forming the sensing electrode 33SP, in plan view perpendicular to the transparent dielectric substrate 33.

Fourteen drive connection lines Lcd arrayed along the first direction D1 in the drive electrode 31DP configure one connection line group, and the connection line groups are disposed along the second direction D2 for the respective cells 21C.

The drive electrode lines 31L which are the components of each of the drive electrodes 31DP may be formed by etching a thin film formed on the drive surface 31S through a mask, or may be formed by physical vapor deposition using a mask, for example, by vacuum deposition or sputtering.

<Touch Sensor Electrode>

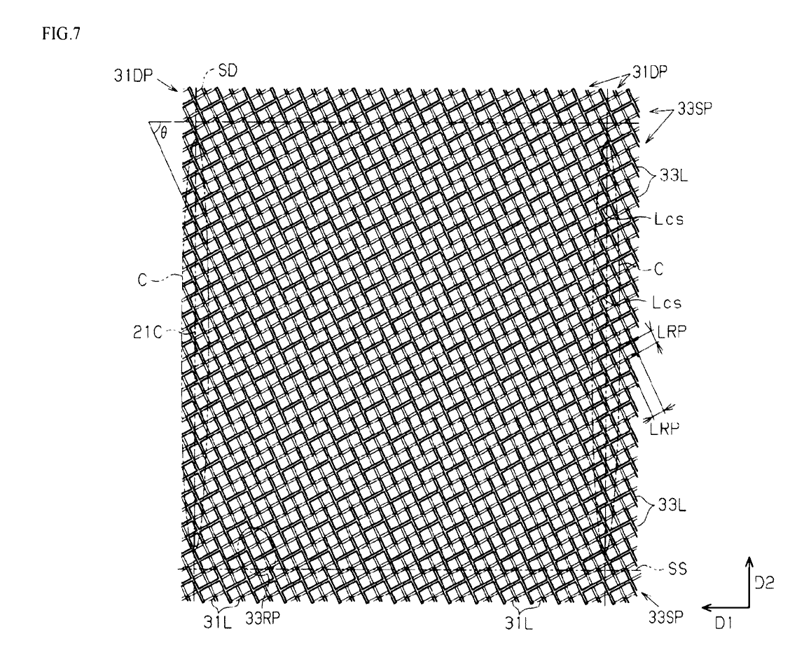

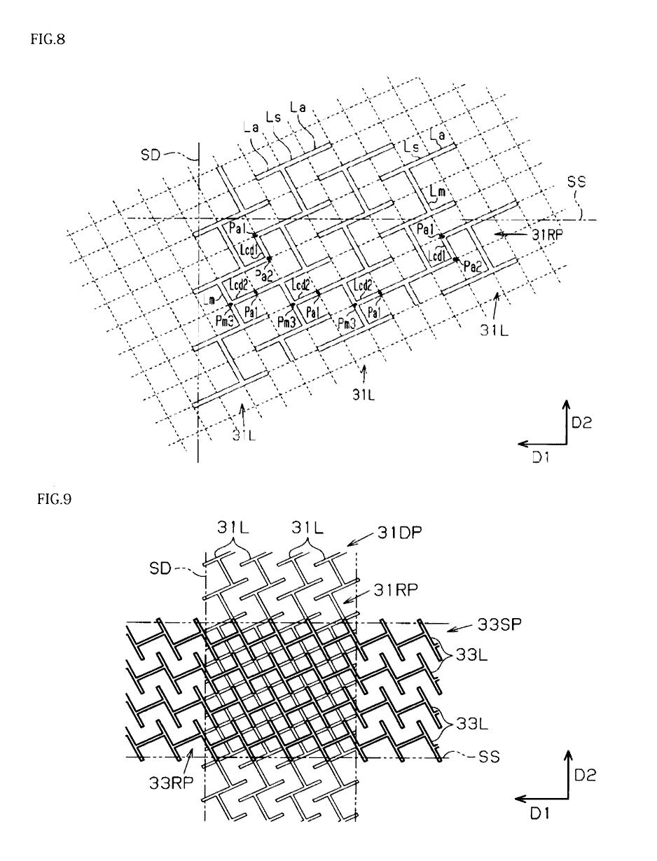

With reference to FIG. 7, a configuration of the touch sensor electrode will be described. FIG. 7 is a plan view showing a planar structure of the drive electrodes 31DP and the sensing electrodes 33SP as viewed from the stacking direction of the electrodes. In FIG. 7, for convenience of describing the arrangement of the plurality of drive electrode lines 31L of the drive electrodes 31DP and the arrangement of the plurality of sensing electrode lines 33L of the sensing electrodes 33SP, the width of each electrode line is illustrated in an exaggerated manner. Further, in FIG. 7, the drive electrode lines 31L are represented with relatively narrow lines, the sensing electrode lines 33L are represented with relatively large lines to easily distinguish the plurality of drive electrode lines 31L of the drive electrode 31DP from the plurality of sensing electrode lines 33L of the sensing electrode 33SP.

As shown in FIG. 7, the sensing electrode 33SP includes a plurality of, e.g. fifteen, sensing electrode lines 33L arrayed along the second direction D2. Each sensing electrode line 33L is made up of a plurality of reference pattern elements 33RP arrayed along the first direction D1. The space between two sensing electrode lines 33L adjacent in the second direction D2 is constant whether the space is inside one sensing electrode 33SP, or whether the space is present between two sensing electrodes 33SP adjacent in the second direction D2.

However, in the fifteen sensing electrode lines 33L forming one sensing electrode 33SP, two sensing electrode lines 33L adjacent in the second direction D2 are electrically connected to each other, while two sensing electrodes 33SP adjacent in the second direction D2 are not electrically connected to each other.

Further, in the sensing electrodes 33SP, a plurality of sensing connection lines Lcs are arrayed along the second direction D2 in area C enclosed by the dash-dot-dot lines in FIG. 7, in the same manner as the drive electrode 31DP. Each sensing connection line Lcs connects two sensing electrode lines 33L adjacent in the second direction.

The drive electrodes 31DP and the sensing electrodes 33SP are three-dimensionally arranged, in plan view perpendicular to the transparent dielectric substrate 33, so that each of the drive electrodes 31DP overlaps with all of the plurality of sensing electrodes 33SP. The drive electrodes 31DP each cooperate with each of the plurality of sensing electrodes 33SP to form a square lattice where one side of each unit square is the unit length LRP. In plan view perpendicular to the transparent dielectric substrate 33, the square lattice is inclined at the main line angle θ relative to the first direction D1 and the second direction D2. In detail, in plan view perpendicular to the transparent dielectric substrate 33, the four sides of each unit square in the square lattice are inclined at the main line angle θ relative to the first direction D1 and the second direction D2. In other words, each unit square in the square lattice has two sides inclined at the main line angle θ relative to the first direction D1, and two sides inclined at the main line angle θ relative to the second direction D2. The unit squares of the square lattice are positioned without a gap therebetween, in the aforementioned plan view, in an area where the sensing electrodes 33SP are arranged in the sensing surface 33S of the transparent dielectric substrate 33.

### Advantageous Effects of Touch Sensor Electrode

### Evaluation of Moiré

### EXAMPLES

Whether or not Moiré was produced on the control surface 20S was evaluated visually in display devices satisfying the following conditions.

Line width of the electrode lines: 7 μm

Main line angle θ: not less than 58° and not more than 68°

First pixel width WP1: not less than 84.6 μm and not more than 633 μm

Second pixel width WP2: not less than 84.6 μm and not more than 633 μm

Third pixel width WP3: not less than 28.2 μm and not more than 211 μm

Whether or not Moiré was produced on the control surface 20S was evaluated in the display devices satisfying the following conditions, setting the unit length LRP of the square lattice to the following range, i.e., setting the length of a diagonal line of each unit square in the square lattice to the following range.

Unit length LRP: not less than 71 μm and not more than 396 μm

Length of the diagonal line of each unit square: not less than 100 μm and not more than 560 μm

It was confirmed that Moiré was prevented on the control surface 20S when the unit length LRP of the square lattices in the Examples was in the following ranges. That is, the it was confirmed that Moiré was prevented when the unit length LRP of the Examples was in any of the range of not less than 92 μm to not more than 113 μm, the range of not less than 170 μm to not more than 212 μm, the range of not less than 240 μm to not more than 247 μm, 283 μm, the range of not less than 311 μm to not more than 354 μm, the range of not less than 375 μm to not more than 382 μm, and 396 μm.

Thus, the Examples showed that Moiré was prevented from being produced on the control surface 20S, at numerous ranges of the unit length LRP of the square lattice.

### Comparative Example 1

It was visually evaluated as to whether or not Moiré was produced on the control surface 20S in the display devices in which only the main line angle θ was changed as described below, for comparison with the examples. The ranges of the unit length LRP of the square lattices which were the targets of evaluation were set to the same ranges as in the Examples.

Main line angle θ: not less than 85° to not more than 90°

It was confirmed that in Comparative Example 1, Moiré was produced in the control surface 20S in all the ranges of the unit length LRP.

### Comparative Example 2

It was visually evaluated as to whether or not Moiré was produced on the control surface 20S in the display devices in which only the main line angle θ was changed as shown below, for comparison with the Examples. The ranges of the unit length LRP of the square lattices which were the targets of evaluation were set to the same ranges as in the Examples.

Main line angle θ: not less than 75° to less than 85°

It was confirmed that in Comparative Example 2 Moiré was prevented from being produced on the control surface 20S only when the unit length LRP was in the following ranges, i.e., the range of 71 μm to not more than 133 μm, and the range of not less than 240 μm to not more than 247 μm.

Thus, while there were ranges of the unit length LRP by which Moiré could be prevented even in Comparative Example 2, they were extremely small compared to the Examples. Therefore, the unit length LRP which could be set in the touch sensor electrode 21 was limited to only a predetermined range. Therefore, the main line angle θ in Comparative Example 2 was not in the range preferable as the main line angle θ of the reference pattern element 31RP in the drive electrode 31DP, and as the main line angle θ of the reference pattern element 33RP in the sensing electrode 33SP.

### Comparative Example 3

It was visually evaluated as to whether or not Moiré was produced on the control surface 20S in the display devices in which only the main line angle θ was changed as shown below, for comparison with the Examples. The ranges of the unit length LRP of the square lattices which were the targets of evaluation were set to the same ranges as in the Examples.

Main line angle θ: larger than 68° and less than 75°

It was confirmed that Comparative Example 3 prevented Moiré on the control surface 20S only when the unit length LRP was in the following ranges, i.e., 92 μm, the range of not less than 127 μm to not more than 134 μm, and the range of not less than 255 μm to not more than 262 μm.

Thus, while there were ranges of the unit length LRP by which Moiré could be prevented even in Comparative Example 3, they were extremely small compared to the Examples. Therefore, the unit length LRP which could be set in the touch sensor electrode 21 was limited to only a predetermined range. Therefore, the main line angle θ in Comparative Example 3 was not in the range preferable as the main line angle θ of the reference pattern element 31RP in the drive electrode 31DP, and as the main line angle θ of the reference pattern element 33RP in the sensing electrode 33SP.

### Comparative Example 4

It was visually evaluated as to whether or not Moiré was produced on the control surface 20S in the display devices in which only the main line angle θ was changed as shown below, for comparison with the examples. The ranges of the unit length LRP of the square lattices which were the targets of evaluation were set to the same ranges as in the Examples.

Main line angle: not less than θ 45° to less than 58°

It was confirmed that Comparative Example 4 prevented Moiré on the control surface 20S only when the unit length LRP was in the following ranges, i.e., the range of not less than 71 μm to not more than 85 μm, the range of not less than 156 μm to not more than 198 μm, and the range of not less than 290 μm to not more than 304 μm.

Thus, while there were ranges of the unit length LRP by which Moiré could be prevented even in Comparative Example 4, they were extremely small compared to the Examples. Therefore, the unit length LRP which could be set in the touch sensor electrode 21 was limited to only a predetermined range. Therefore, the main line angle θ in Comparative Example 4 was not in the range preferable as the main line angle θ of the reference pattern element 31RP in the drive electrode 31DP, and the main line angle δ of the reference pattern element 33RP in the sensing electrode 33SP.

<Resistance to Cutting>

Each of the drive electrodes 31DP provided to the touch sensor electrode 21 has a group of drive connection lines Lcd in each cell 21C, and each of the sensing electrodes 33SP has a group of sensing connection lines Lcs in each cell 21C. Therefore, for example, if one drive electrode line 31L which is a component of one drive electrode 31DP is cut at a point midway in the second direction D2, a part of the drive electrode line 31L can function as the drive electrode 31DP through other drive electrode lines 31L. Moreover, all of the drive electrode lines 31L which are provided to the drive electrode 31DP are each connected to the drive electrode line 31L adjacently located in the first direction D1, thus, there is a high possibility that the drive electrode line 31L cut midway in the second direction D2 functions as the drive electrode 31DP through other drive electrode lines 31L.

Furthermore, a group of drive connection lines Lcd is disposed in each cell 21C. Therefore, if one drive electrode line 31L is cut at two points midway in the second direction D2, the portions other than the portion sandwiched by the cut points in the second direction D2 can function as the drive electrode 31DP through other drive electrode lines 31L. Furthermore, when the portion sandwiched by the cut points in the second direction D2 includes a drive connection line Lcd connected to other drive electrode lines 31L, the portion can function as the drive electrode 31DP through other drive electrode lines 31L.

Such advantageous effects are not limited to the drive electrodes 31DP of the touch sensor electrode 21, but can be obtained by the sensing electrodes 33SP.

<Sheet Resistance>

As stated above, the drive electrodes 31DP of the touch sensor electrode 21 each have a group of drive connection lines Lcd in each cells 21C, and the sensing electrodes 33SP each have a group of sensing connection lines Lcs in each cells 21C. Therefore, the current supplied from the selection circuit 34 to each of the drive electrodes in 31DP flows through the fourteen drive connection lines Lcd between the two cells 21C arranged along the second direction D2.

Therefore, sheet resistance in the drive electrode 31DP can be made lower compared to the configuration in which, for example, the current passes through one drive connection line Lcd between two cells 21C arranged along the second direction D2. As a result, the transmission rate of the signal outputted from the selection circuit 34 to the drive electrodes 31DP can be prevented from becoming low.

Such advantageous effects are not limited to the drive electrodes 31DP of the touch sensor electrode 21, but can be obtained by the sensing electrodes 33SP.

As described above, the first embodiment can obtain the advantageous effects as follows.

(1) A display device including the touch panel 20 is provided with a plurality of pixels 15P arrayed in a matrix pattern along the first direction D1 in which the drive electrodes 31DP are arrayed, and the second direction D2 in which the sensing electrodes 33SP are arrayed. The square lattice formed by the drive electrodes 31DP and the sensing electrodes 33SP has an inclination of not less than 58° and not more than 68° with respect to the direction in which the plurality of pixels 15P are arrayed. This configuration can prevent the occurrence of Moiré which would be caused by the arrangement of the plurality of electrodes in the touch sensor electrode 21 and the arrangement of the plurality of pixels 15P.

(2) Each drive electrode 31DP has the drive connection lines Lcd each connecting the drive electrode lines 31L adjacent to each other in the first direction D1, in every portion where the drive electrode 31DP intersects with a sensing electrode 33SP. On the one hand, each sensing electrode 33SP has the sensing connection lines Lcs each connecting the sensing electrode lines 33L adjacent to each other in the second direction D2, in every portion where the sensing electrode 33SP intersects with a drive electrode 31DP.

Therefore, if a drive electrode line 31L connected to other drive electrode lines 31L is cut at points midway in the second direction D2, a part of the drive electrode line 31L in question can function as the drive electrode 31DP through other drive electrode lines 31. Further, if a sensing electrode line 33L connected to other sensing electrode lines 33L is cut at points midway in the first direction D1, a part of the sensing electrode line 33L in question can function as the sensing electrode 33SP through other sensing electrode lines 33L. Therefore, the touch sensor electrode 21 has a high durability to cutting of the electrode lines of the drive electrode 31DP or the sensing electrode 33SP.

The aforementioned first embodiment can be appropriately modified and implemented as follows.

Specifically, the drive connection line Lcd does not need to have a linear shape extending from the second main endpoint Pm2 to the first auxiliary endpoint Pa1 of another reference pattern element 31RP.

As shown in FIG. 8, a drive connection line Lcd1 may be a straight line having the unit length LRP, extending along the main line direction from the first auxiliary endpoint Pa1 of a reference pattern element 31RP of a drive electrode line 31L. In this case, the drive connection line Lcd1 extends from the first auxiliary endpoint Pa1 to the second auxiliary endpoint Pa2 of a reference pattern element 31RP of the drive electrode lines 31L adjacent in the first direction D1.

Alternatively, a drive connection line Lcd2 may be a straight line having the unit length LRP, extending along an extension direction from a center point Pm3 of the main line Lm in the main line direction, in a reference pattern element 31RP of a drive electrode lines 31L. In this case, the drive connection line Lcd2 extends from the center point Pm3 of the main line Lm to the first auxiliary endpoint Pa1 of a reference pattern element 31RP of the drive electrode line 31L adjacent in the first direction D1.

Thus, the drive connection line Lcd may be a straight line overlapping or not overlapping with the sensing electrode 33SP in plan view, extending, with a reference pattern element 31RP of a drive electrode line 31L as a starting point, to a reference pattern 31RP of the drive electrode line 31L adjacent in the first direction D1.

The three drive connection lines described above may be used in combination in a drive electrode 31DP. In short, of the three drive connection lines, at least two drive connection lines may be included in the fourteen drive connection lines arrayed along first direction D1.

The sensing connection line Lcs does not have to have a linear shape as well, extending from the second main endpoint Pm2 to the first auxiliary endpoint Pa1 of another reference pattern element 33RP. That is, in the same manner as the drive connection line Lcd, the sensing connection line Lcs may be or may not be a straight line overlapping with the drive electrode 31DP in plan view, extending, with a reference pattern element 33RP of a sensing electrode line 33L as a starting point, to a reference pattern element 33RP of the sensing electrode line 33L adjacent in the second direction D2.

In each drive electrode 31DP, only some sets of drive electrode lines 31L adjacent in the first direction D1 among a plurality of sets may have the drive connection lines Lcd. If two drive electrode lines 31L adjacent in the first direction D1 among the drive electrode lines 31L of each drive electrode 31DP are connected via the drive connection line Lcd in each cell 21C, advantages similar to those mentioned in (2) can be obtained. That is, if each drive electrode 31DP includes at least one drive connection line Lcd, advantages similar to those mentioned in (2) can be obtained.

The drive connection line is not limited to the three drive connection lines described above. Basically, in the two drive electrodes 31DP adjacent in the first direction D1, the drive connection line only has to be a straight line extending from a reference pattern element 31RP of one drive electrodes 31DP towards a reference pattern element 31RP of the other drive electrode 31DP. Additionally, the drive electrode line having the unit length LRP may or may not overlap a part of a sensing electrode 33SP in plan view.

The drive connection lines Lcd in each drive electrode 31DP do not have to be disposed in each cell 21C, but only have to be disposed in at least one location in the second direction D2.

In each sensing electrode 33SP, only some of the sets of the sensing electrode lines 33L adjacent in the second direction D2 among a plurality of sets may have the sensing connection lines Lcs. Among the sensing electrode lines 33L of each sensing electrode 33SP, if two sensing electrode lines 33L adjacent in the second direction D2 are connected via a sensing connection line Lcs in each cell 21C, advantages similar to those mentioned in (2) can be obtained. That is, if each sensing electrode 33SP includes at least one sensing connection line Lcs, advantages similar to those mentioned in (2) can be obtained.

In two sensing electrodes 33SP adjacent in the second direction D2, the sensing connection line Lcs only has to be a straight line extending from a reference pattern element 33RP of one sensing electrode 33SP to a reference pattern element 33RP of the other sensing electrode 33SP. The sensing electrode line having the unit length LRP may or may not overlap with the a part of a drive electrode 31DP in plan view.

The sensing connection lines Lcs in each sensing electrode 33SP do not have to be disposed in each cell 21C, but may be disposed in at least one location in the first direction D1.

Each drive electrode 31DP does not have to have a drive connection line Lcd. As far as the drive electrode lines 31L forming each drive electrode 31DP are each formed of the plurality of the reference pattern elements 31RP, advantages similar to those mentioned in (1) can be obtained.

Each sensing electrode 33SP does not have to have a sensing connection line Lcs. As far as the sensing electrode lines 33L forming each sensing electrode 33SP are each formed of the plurality of the reference pattern elements 33RP, advantages similar to those mentioned in (1) can be obtained.

The number of the drive connection lines Lcd and the positions thereof in each drive electrode 31DP may be different from the number of sensing connection lines Lcs and the positions thereof in each sensing electrode 33SP.

As shown in FIG. 9, the number of drive electrode lines 31L provided to each drive electrode 31DP does not have to be fifteen, and may be four, for example. Also, the number of sensing electrode lines 33L provided to each sensing electrode 33SP does not have to be fifteen, and may be four, for example. Thus, the number of drive electrode lines 31L provided to each drive electrode 31DP, and the number of sensing electrode lines 33L provided to each sensing electrode 33SP can be determined as desired as far as the number is two or more. Moreover, as far as each drive electrode line 31L includes a plurality of reference pattern elements 31RP and each sensing electrode line 33L includes a plurality of reference pattern elements 33RP, advantages similar to those mentioned in (1) can be obtained, regardless of the number of drive electrode lines 31L and the number of sensing electrode lines 33L.

### Second Embodiment

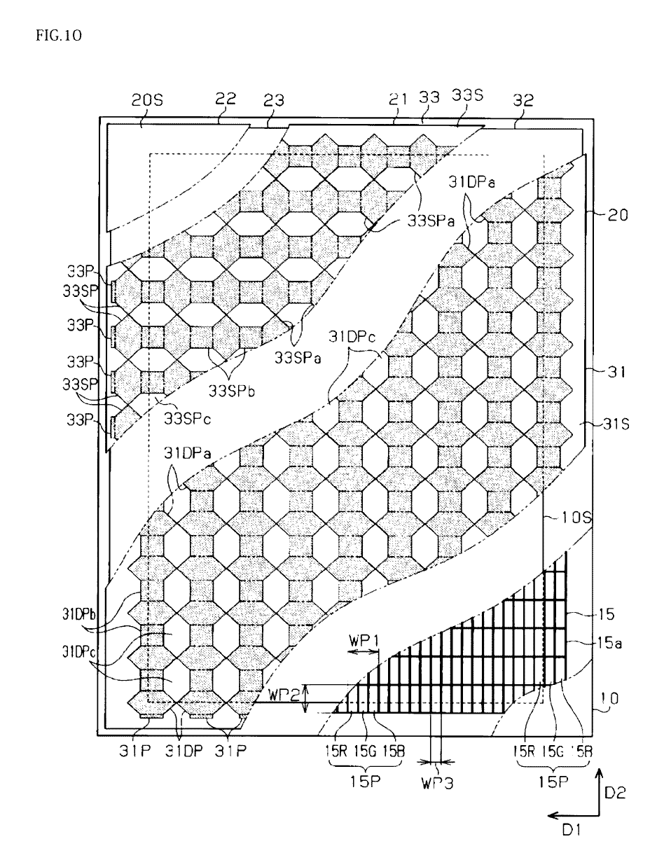

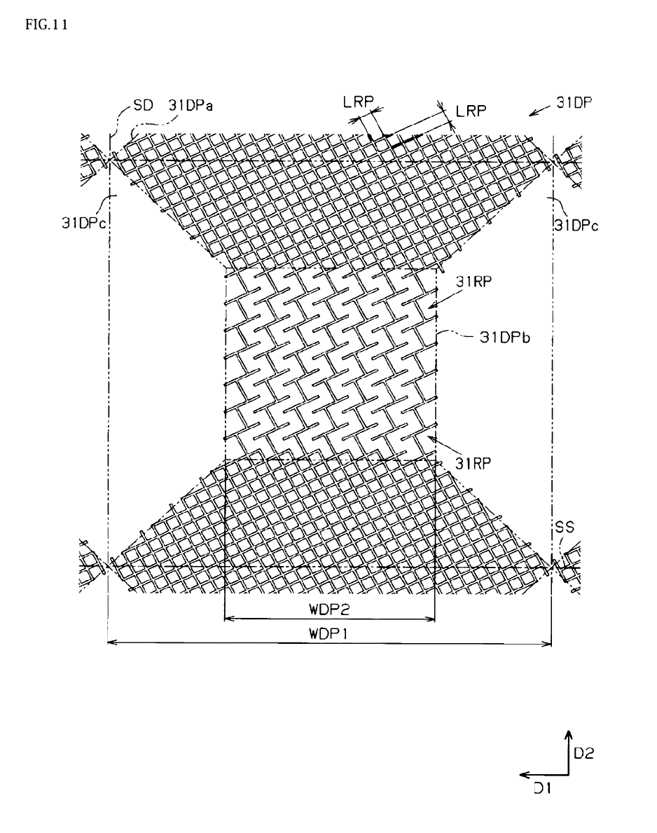

With reference to FIGS. 10 to 14, a touch sensor electrode, a touch panel, and a display device embodied by the second embodiment will be described. The second embodiment, compared to the first embodiment, is different mainly in the configuration of the drive electrode 31DP and the configuration of the sensing electrode 33SP. Therefore, the points of difference will be described in detail below and a detailed description will be omitted regarding the rest of the configuration. Further, in the second embodiment, the components equivalent to those of the first embodiment are designated with the same reference signs used for the first embodiment. Moreover, the configuration of the display device, the configuration of the drive electrode, the configuration of the touch sensor electrode, and the advantageous effects of the touch sensor electrode will be described in order below.

<Display Device>

With reference to FIG. 10, the display device will be described. In FIG. 10, similar to FIG. 1, for convenience of describing configurations, a color filter layer, a drive electrode, and a sensing electrode provided to the display device are illustrated in an exaggerated manner. Further, in FIG. 10, the plurality of drive electrodes 31DP and the plurality of sensing electrodes 33SP are dotted for convenience of illustration.

As shown in FIG. 10, in the drive surface 31S of the transparent substrate 31, the plurality of drive electrodes 31DP are arrayed along the first direction D1 and are extended along the second direction D2 perpendicular to the first direction D1. Each drive electrode 31DP includes a plurality of drive detection units 31DPa arrayed along the second direction D2, and drive connection units 31DPb each connecting between two drive detection units 31DPa adjacent in the second direction D2. The drive detection unit 31DPa is configured by the square units of the square lattice, which include the reference pattern elements 31RP, and the drive connection unit 31DPb configured by the reference pattern elements 31RP. In each drive electrode 31DP, the drive detection unit 31DPa is an example of the wide part and has, for example, a hexagonal shape. The drive connection unit 31DPb is an example of the narrow part, and has, for example, a rectangular shape, and has a side shared with one of the drive detection units 31DPa adjacent in the second direction D2 and another side shared with the other of the drive detection units 31DPa.

In the plurality of drive electrodes 31DP, the plurality of drive detection units 31DPa are arrayed along the first direction D1, and the plurality of drive connection units 31DPb are arrayed along the first direction D1. The drive detection units 31DPa adjacent in the first direction D1 are arrayed in a state of their hexagonal vertexes facing each other, and not being electrically connected to each other. Thus, between two drive electrodes 31DP adjacent in the first direction D1, a drive space 31DPc having a hexagonal shape is defined by four drive detection units 31DPa and two drive connection units 31DPb. A plurality of such drive spaces 31DPc are arrayed along the first direction D1.

The plurality of sensing electrodes 33SP are arrayed along the sensing surface 33S of the transparent dielectric substrate 33 in the second direction D2, and are extended along the first direction D1 perpendicular to the second direction D2. Each sensing electrode 33SP includes a plurality of sensing detection units 33SPa arrayed along the first direction D1, and sensing connection units 33SPb each connecting between two sensing detection units 33SPa adjacent in the first direction D1. The sensing detection unit 33SPa is configured by the square units of the square lattice, which include the reference pattern elements 33RP, and the sensing connection unit 33SPb is configured by the reference pattern elements 33RP.

The sensing detection unit 33SPa in each sensing electrode 33SP is an example of the wide part, and has, for example, a in hexagonal shape. The sensing connection unit 33SPb is an example of the narrow part, and has, for example, a rectangular shape, and has a side shared with one of sensing detection units 33SPa adjacent in the first direction D1 and another side shared with the other of the sensing detection units 33SPa. Each sensing detection unit 33SPa has a shape and size equivalent to a drive space 31DPc, and each sensing connection unit 33SPb has a shape and size equivalent to a drive connection unit 31DPb.

The plurality of sensing detection units 33SPa in the plurality of sensing electrodes 33SP are arrayed along the second direction D2, and the plurality of sensing connection units 33SPb are arrayed along the second direction D2. The sensing detection units 33SPa adjacent in the second direction D2 are arrayed in a state of their hexagonal vertexes facing each other, and not being electrically connected to each other. Thus, between two sensing electrodes 33SP adjacent in the second direction D2, a sensing space 33SPc having a hexagonal shape is defined by four sensing detection units 33SPa and two sensing connection units 33SPb, and a plurality of such sensing spaces 33SPc are arrayed along the second direction D2. Each sensing space 33SPc has a shape and size equivalent to a drive detection unit 31DPa.

A drive connection unit 31DPb overlaps with a sensing connection unit 33SPb in plan view perpendicular to the transparent dielectric substrate 33. Further, in plan view perpendicular to the transparent dielectric substrate 33, a drive detection unit 31DPa is positioned between the sensing electrodes 33SP adjacent in the second direction D2, and is positioned between two sensing detection units 33SPa adjacent in the first direction D1.

On the one hand, in plan view perpendicular to the transparent dielectric substrate 33, a sensing detection unit 33SPa is positioned between the drive electrodes 31DP adjacent in the first direction D1, and is positioned between two drive detection units 31DPa adjacent in the second direction D2. That is, a drive detection unit 31DPa is positioned in a sensing space 33SPc, and a sensing detection unit 33SPa is positioned in a drive space 31DPc.

<Drive Electrode>

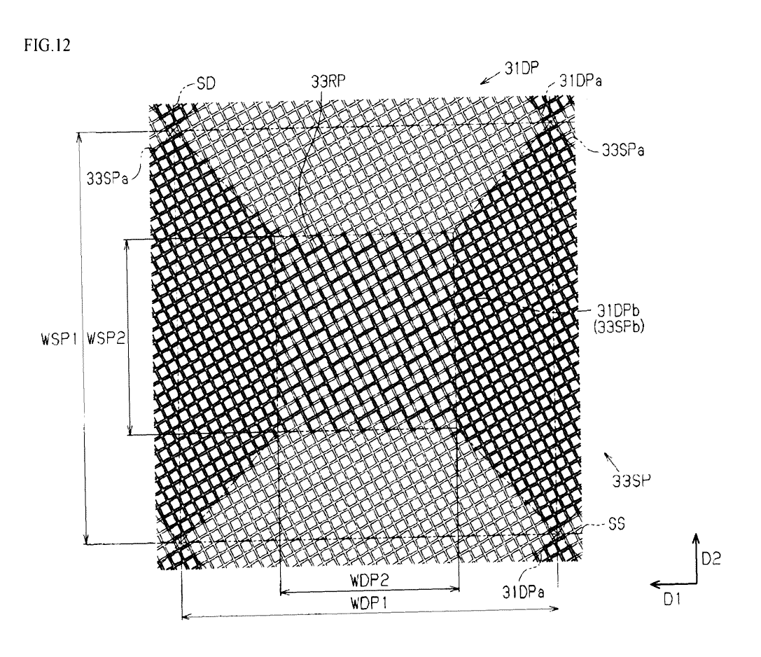

With reference to FIG. 11, the drive electrode will be described. FIG. 11 is a plan view showing a planar structure of a part in the drive electrode 31DP. In FIG. 11, for convenience of the description of the arrangement of the plurality of electrode lines of the drive electrode 31DP, the width of the electrode lines is illustrated in an exaggerated manner. Compared to the drive electrode 31DP, the sensing electrode 33SP is different in the point that the reference direction of the reference pattern elements forming the sensing electrode 33SP is in the second direction D2. However, the configuration of the electrode lines of the sensing electrode 33SP is equivalent to that of the electrode lines forming the drive electrode 31DP. Therefore, although the configuration of the drive electrode 31DP is described in detail below, a detailed description on the configuration of the sensing electrode 33SP is omitted.

Among the dash-dot-dot lines in FIG. 11, the straight ones extending along the second direction D2 are each positioned between two drive electrodes 31DP adjacent in the first direction D1. An area extending along the second direction D2 and sandwiched between two dash-dot-dot lines adjacent in the first direction D1 represents a drive electrode line area SD that is a range occupied by one drive electrode 31DP.

A drive electrode width WDP1 represents the width of a drive electrode 31DP in the first direction D1. With this width, fifteen reference pattern elements 31RP can be arrayed along the first direction D1. The drive electrode width WDP1 is the maximum width along the first direction D1 in the drive detection unit 31DPa. On the one hand, a drive connection width WDP2 represents the width of the drive connection unit 31DPb in the first direction D1. With this width, seven reference pattern elements 31RP can be arrayed along the first direction D1. In the drive connection unit 31DPb, seven reference pattern elements 31RP are arrayed along the first direction D1, and seven reference pattern elements 31RP are arrayed in series along the second direction D2.

The drive detection unit 31Dpa has a hexagonal shape as stated above and is formed of two linearly symmetric trapezoidal portions when a straight line passing through a portion, i.e. the maximum width portion of the drive detection unit 31DPa, between the two vertices is set as the symmetric axis. In each trapezoidal portion, the width along the first direction D1 gradually becomes smaller from the drive electrode width WDP1 which is the greatest width to the drive connection width WDP2.

The drive detection unit 31DPa includes a plurality of reference pattern elements 31RP arrayed along the first direction D1 and arrayed in series along the second direction D2. The drive detection unit 31DPa has portions where the reference pattern elements 31RP are not located. In each of these portions, a reference pattern element 33RP using the second direction D2 as a reference direction is entirely or partially located. The drive detection unit 31DPa is formed of a square lattice including unit squares each having the unit length LRP on a side.

Each drive detection unit 31DPa has an outer rim where the reference pattern element 31RP or the reference pattern element 33RP are partially located. Of the partially located elements, a part of a reference pattern element 31RP forms a reference pattern element 31RP with a part of a reference pattern element 33RP located on the outer rim of the sensing detection unit 33SPa adjacent in the second direction D2, in plan view perpendicular to the transparent dielectric substrate 33.

On the one hand, a part of a reference pattern element 33RP forms a reference pattern element 33RP with a part of a reference pattern element 31RP located on the outer rim of the drive detection unit 31SPa adjacent in the first direction D1, in plan view perpendicular to the transparent dielectric substrate 33. Thereby, a square lattice is provided in each of portions where the sensing electrodes 33SP are located on the sensing surface 33S. In the square lattice, unit squares each having the unit length LRP on a side are disposed without a gap therebetween, in plan view perpendicular to the transparent dielectric substrate 33.

<Touch Sensor Electrode>

With reference to FIG. 12, the touch sensor electrode 21 will be described. Similar to FIG. 7, FIG. 12 is a plan view showing a planar structure when viewed in a direction in which the drive electrodes 31DP and the sensing electrodes 33SP are stacked. In FIG. 12, similar to FIG. 7, for convenience of description of the arrangement of the plurality of electrode lines which form the drive electrodes 31DP and the arrangement of the plurality of electrode lines which form the sensing electrodes 33SP, the width of the electrode lines is illustrated in an exaggerated manner. Further, in FIG. 12, the drive electrode line 31L is shown by a relatively narrow line and the sensing electrode line 33L is shown by a relatively large line in order to easily distinguish the plurality of electrode lines which configure the drive electrodes 31DP from the plurality of electrode lines which configure the sensing electrodes 33SP.

As shown in FIG. 12, a sensing electrode width WSP1 represents the width of the sensing electrode 33SP in the second direction D2. With this width, fifteen reference pattern elements 33RP can be arrayed along the second direction D2. On the one hand, a sensing connection width WSP2 represents the width of the sensing connection unit 33SPb in the second direction D2. With this width, seven reference pattern elements 33RP can be arranged along the second direction D2.

In the sensing connection unit 33SPb, seven reference pattern elements 33RP are arranged along the second direction D2 and seven reference pattern elements 33RP are arrayed in series along the first direction D1. The sensing detection unit 33SPa includes the plurality of reference pattern elements 33RP arranged along the second direction D2 and arrayed in series along the first direction D1. The sensing detection unit 33Spa has portions where the reference pattern elements 33RP are not located. In each of these portions, a reference pattern elements 31RP is entirely or partially located.

The drive connection units 31DPb of the drive electrodes 31DP and the sensing connection units 33SPb of the sensing electrodes 33SP overlap three-dimensionally in plan view perpendicular to the transparent dielectric substrate 33. Thus, in the portion where two connection units overlap each other, a square lattice is formed by the plurality of reference pattern elements 31RP and the plurality of reference pattern elements 33RP.

On the one hand, a sensing detection unit 33SPa of the sensing electrode 33SP is positioned in a drive space 31DPc in plan view perpendicular to the transparent dielectric substrate 33. Therefore, the drive detection unit 31DPas of the drive electrodes 31DP do not overlap with the sensing detection units 33SPa of the sensing electrodes 33SP, in plan view perpendicular to the transparent dielectric substrate 33.

However, the drive detection unit 31DPa and the sensing detection unit 33SPa each have a square lattice. Thus, a part of a reference pattern element located on the outer rim of the drive detection unit 31DPa forms a square unit of the square lattice with a part of a reference pattern element located on the outer rim of the sensing detection unit 33SPa adjacent in the second direction D2. Further, a part of a reference pattern element located on the outer rim of the sensing detection unit 33SPa forms a square unit of the square lattice with a part of a reference pattern element located on the outer rim of the drive detection units 31DPa adjacent in the first direction D1. Thus, in plan view perpendicular to the transparent dielectric substrate 33, there is provided a square lattice where unit squares each having the unit length LRP on a side are disposed without a gap therebetween, in each of portions where the sensing electrodes 335P are disposed on the sensing surface 33S.

### <Advantageous Effects of Touch Sensor Electrode>

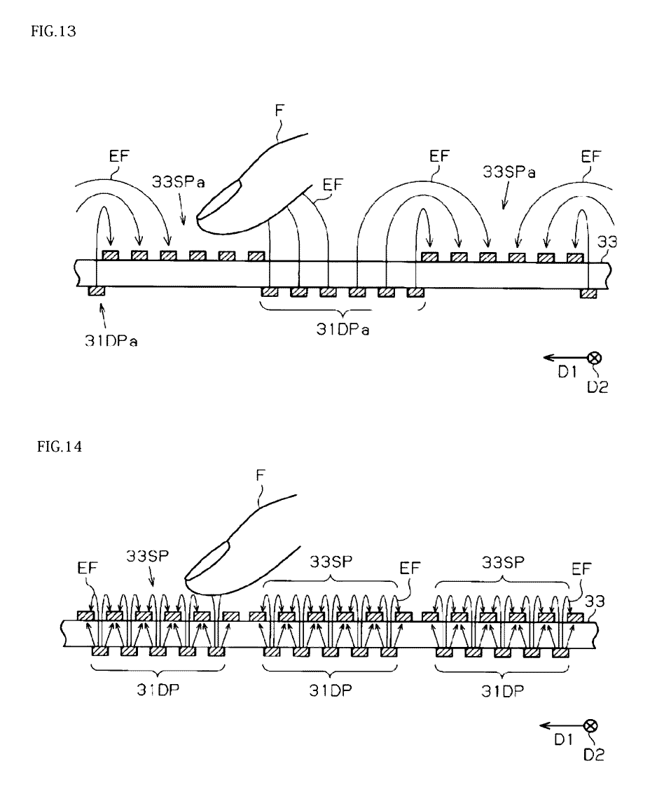

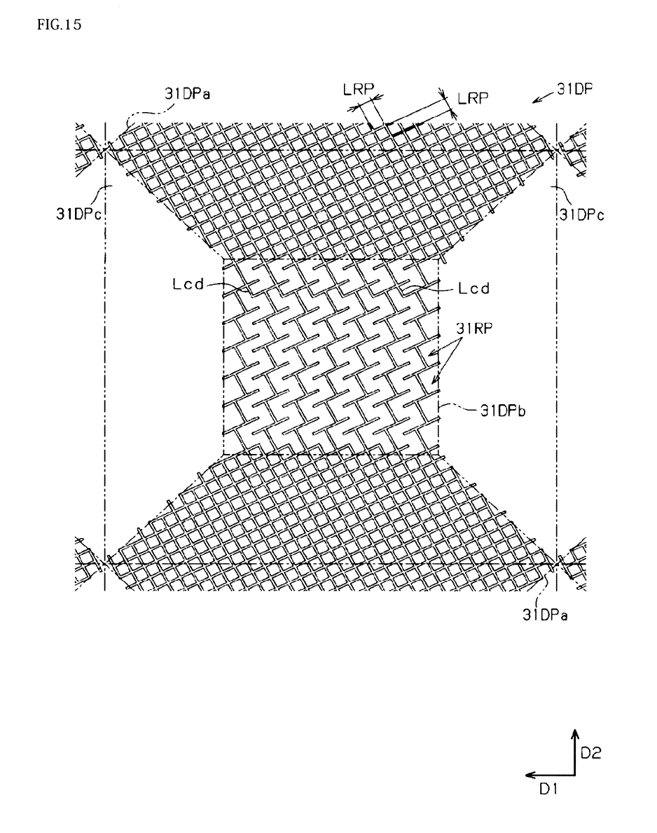

With reference to FIG. 13 and FIG. 14, advantageous effects of the touch sensor electrode will be described. In FIGS. 13 and 14, for convenience of description, the transparent substrate 31 on which the drive electrodes 31DP are disposed is not illustrated.

As shown in FIG. 13, the selection circuit 34 outputs a drive signal to the drive electrodes 31DP. For example, in plan view perpendicular to the transparent dielectric substrate 33, an electric field EF is formed between a drive detection unit 31DPa and a sensing detection unit 33SPa adjacent to each other in the first direction D1, or specifically, between an electrode line configuring the drive detection unit 31DPa and an electrode line configuring the sensing detection unit 33SPa. In this case, since the drive detection unit 31DPa and the sensing detection unit 33SPa do not overlap with each other in a plan view perpendicular to the transparent dielectric substrate 33, the electric field EF extends diagonally from the electrode line of the drive detection unit 31DPa towards the electrode line of the sensing detection unit 33SPa. Therefore, the length of the electric field EF formed between the two electrode lines becomes larger.

When a person's finger F approaches such a touch sensor electrode 21, the electric field EF which contacted the finger F is discharged via the person's body, and thus the magnitude of the 11) electrostatic capacitance formed between the drive electrode 31DP and the sensing electrode 33SP changes. As stated above, the electric field EF extends diagonally from the electrode line of the drive detection unit 31DPa towards the electrode line of the sensing detection unit 33SPa, and thus the electric field EF is easily influenced by the person's finger F. Therefore, the sensitivity of the touch sensor electrode 21 to the contact of the person's finger F increases. As a result, the sensitivity for detecting the position of the person's finger F increases.

On the one hand, as shown in FIG. 14, in the touch sensor electrode 21 of the first embodiment, the electrostatic capacitance is formed in a portion where the electrode lines forming the drive electrode 31DP intersect three-dimensionally with the electrode lines forming the sensing electrode 33SP, in plan view perpendicular to the transparent dielectric substrate 33. Therefore, during the output of a drive signal to the drive electrode 31DP to the selection circuit 34, the electric field EF having a substantially linear shape extends from one electrode line of the drive electrode 31DP towards one electrode line of the sensing electrode 33SP. Therefore, when the person's finger F approaches the touch sensor electrode 21, the state of the electric field EF does not change greatly before and after the approach of the finger F. As a result, the resistance of the touch panel 20 to noise inputted to the touch sensor electrode 21 is enhanced.

As described above, the second embodiment can obtain the advantageous effects as follows.

(3) A change in electrostatic capacitance between the drive detection unit 31DPa and the sensing detection unit 33SPa not overlapping each other in plan view perpendicular to the transparent dielectric substrate 33 is measured by a peripheral circuit provided to the touch sensor. Therefore, for example, when a conductor such as a person's finger F approaches between the drive detection unit 31DPa and the sensing detection unit 33SPa, the electrostatic capacitance formed between the drive detection unit 31DPa and the sensing detection unit 33SPa is likely to be greatly changed. Therefore, in the touch sensor provided to the touch sensor electrode 21, sensitivity for detecting the position of contact of a person's finger F is enhanced.

The aforementioned second embodiment can be appropriately modified and implemented as follows.

As shown in FIG. 15, a drive connection unit 31DPb may have drive connection lines Lcd. In the drive connection unit 31DPb, the drive connection lines Lcd each connect between the reference pattern elements 31RP adjacent the first direction D1. The position where one end of a drive connection line Lcd is located in one reference pattern element 31RP and the position where the other end thereof is located in the other reference pattern element 31RP may be the same as in the first embodiment or in the modifications of the first embodiment. Further, if a drive connection unit 31DPb has at least one drive connection line Lcd, advantages similar to those mentioned in (2) can be obtained.

A sensing connection unit 33SPb may have sensing connection lines Lcs. In the sensing connection unit 33SPb, the sensing connection lines Lcs each connects between the reference pattern elements 33RP adjacent in the second direction D2. The position in where one end of a sensing connection line Lcs is located in one reference pattern element 33RP and the position where the other end thereof is located in the other reference pattern element 33RP may be the same as in the first embodiment, or in the modifications of the first embodiment. Further, if a sensing connection unit 33SPb has at least one sensing connection line Lcs, advantages similar to those mentioned in (2) can be obtained.

The drive electrode width WDP1 does not have to be a width with which fifteen reference pattern element 31RP can be arrayed along the first direction D1, and the drive connection width WDP2 does not have to be a width with which seven reference pattern elements 31RP can be arrayed along the first direction D1. Further, the sensing electrode width WSP1 does not have to be a width with which fifteen reference pattern elements 33RP can be arrayed along the second direction D2, and the sensing connection width WSP2 does not have to be a width with which seven reference pattern elements 33RP can be arrayed along the second direction D2.

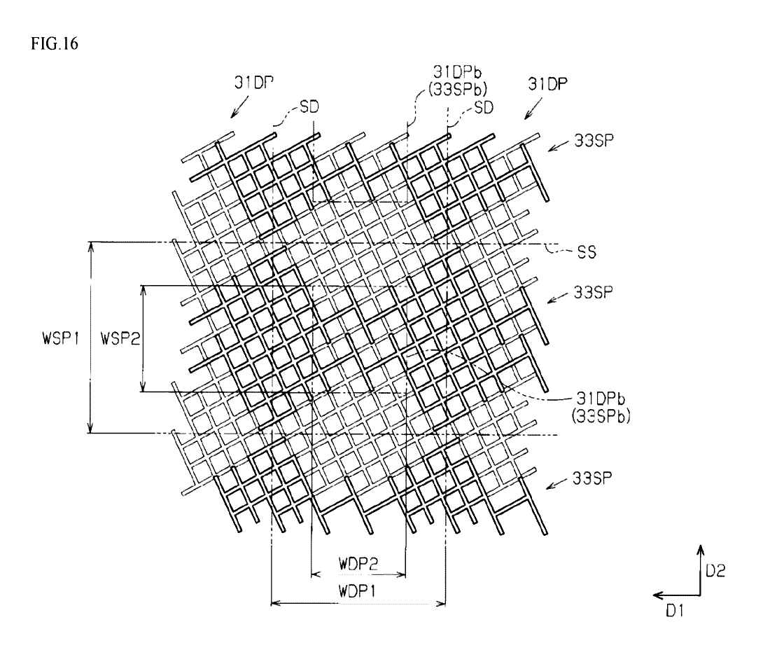

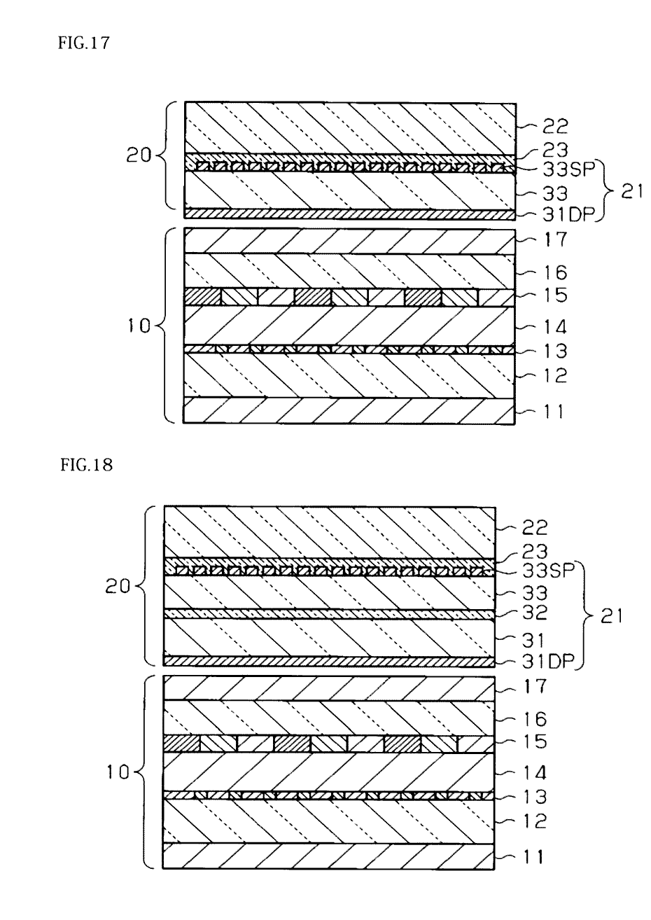

As shown in FIG. 16, for example, the drive electrode width WDP1 may be a width with which four reference pattern elements 31RP can be arrayed along the first direction D1, and the drive connection width WDP2 may be a width with which two reference pattern elements 31RP can be arrayed along the first direction D1. The sensing electrode width WSP1 may be a width with which four reference pattern elements 33RP can be arrayed along the second direction D2, and the sensing connection width WSP2 may be a width with which two reference pattern elements 33RP can be arrayed along the second direction D2.

Thus, the drive electrode width WDP1, the drive connection width WDP2, the sensing electrode width WSP1, and the sensing connection width WSP2 can be appropriately modified. Furthermore, the ratio of the drive electrode width WDP1 and the drive connection width WDP2, and the ratio of the sensing electrode width WSP1 and the sensing connection width WSP2 can also be appropriately modified.

The drive detection unit 31DPa only have to be disposed between the sensing electrodes 33Sp adjacent in the second direction D2, and only have to be disposed between two sensing detection units 33SPa adjacent in the first direction D1. In short, in plan view perpendicular to the transparent dielectric substrate 33, the drive detection unit 31DPa may have a portion overlapping the sensing detection unit 33SPa. This configuration, if the drive detection unit 31DPa is disposed between the sensing electrodes 33SP adjacent in the second direction D2, and is disposed between two sensing detection units 33SPa adjacent in the first direction D1, can obtain advantages similar to those mentioned in (3).

<Other Modifications>

The first and the second embodiments can be appropriately modified and implemented as follows.

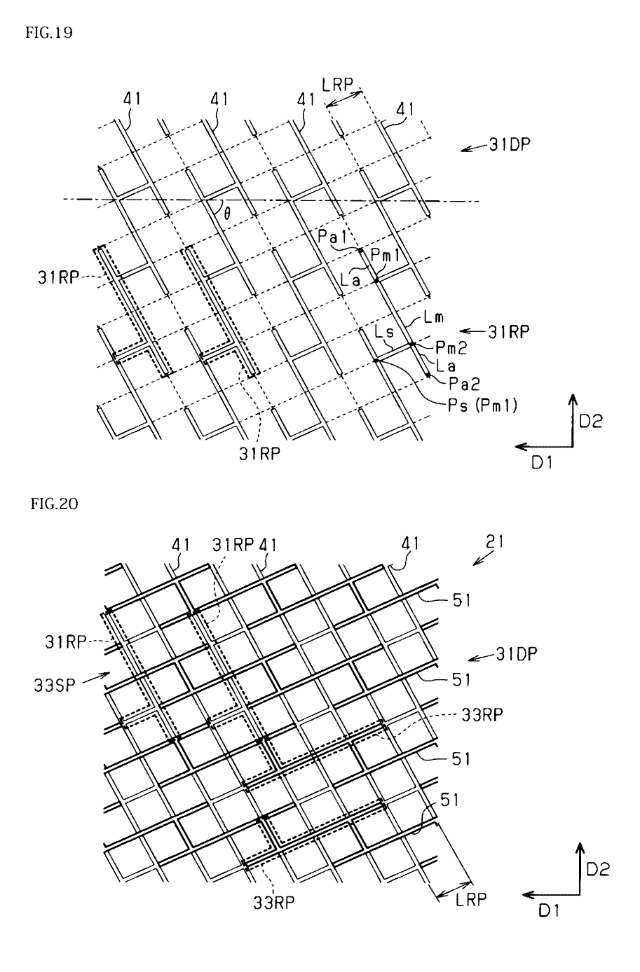

As shown in FIG. 17, in the touch sensor electrode 21 forming the touch panel 20, the transparent substrate 31 and the transparent adhesive layer 32 may be omitted. With this configuration, of the surfaces of the transparent dielectric substrate 33, one surface facing the display panel 10 may be determined as the drive surface 31S, and the drive electrodes 31DP may be disposed on the drive surface 31S. Moreover, the sensing electrodes 33SP may be disposed on a surface of the transparent dielectric substrate 33, which is opposite to the drive surface 31S.

With this configuration, the drive electrodes 31DP is formed, for example, by patterning one thin film formed on the drive surface 31S.

As shown in FIG. 18, in the touch panel 20, the drive electrodes 31DP, the transparent substrate 31, the transparent adhesive layer 32, the transparent dielectric substrate 33, the sensing electrodes 33SP, the transparent adhesive layer 23 and the cover layer 22 may be disposed, in order from the component closer to the display panel 10.

With this configuration, for example, the drive electrodes 31DP are formed on the drive surface 31S which is one surface of the transparent substrate 31, and the sensing electrodes 33SP are formed on the sensing surface 33S which is one surface of the transparent dielectric substrate 33. Then, the surface or the transparent substrate 31, which is opposite to the drive surface 31S, and the surface the transparent dielectric substrate 33, which is opposite to the sensing surface 33S, are adhered by the transparent adhesive layer 32.

The touch panel 20 and the display panel 10 do not have to be formed separately, but the touch panel 20 may be formed integrally with the display panel 10. With this configuration, for example, the plurality of drive electrodes 31DP of the touch sensor electrodes 21 can be disposed on the TFT layer 13, while the plurality of sensing electrodes 33SP can be disposed between the color filter substrate 16 and the upper polarizer 17 to provide an in-cell configuration. Alternatively, the touch sensor electrode 21 may be disposed between the color filter substrate 16 and the upper polarizer 17 to provide an on-cell configuration.

<First Modification>

Alternative to the reference pattern elements 31RP described above, the reference pattern elements 31RP described below with reference to FIGS. 19 and 20 may be used.

As shown in FIG. 19, the drive electrode 31DP is an assembly of a plurality of drive electrode lines 41. The plurality of drive electrode lines 41 are arranged at equal intervals along the first direction D1, and each of the plurality of drive electrode lines 41 extends along the second direction D2. Each drive electrode line 41 is formed of a plurality of reference pattern elements 31RP. In the drive electrode lines 41, the plurality of reference pattern elements 31RP are arrayed along the second direction D2.

Each reference pattern element 31RP includes one main line Lm and one sub-line Ls. The main line Lm has a linear shape and forms a main line angle θ, that is a predetermined angle, relative to the first direction D1 that is a reference direction in the drive electrode 31DP. The main line Lm extends from a first main endpoint Pm1 to a second main endpoint Pm2. The main line angle θ is a predetermined angle in the range of not less than 58° to not more than 68°, and preferably is 63.435°. A direction which forms the main line angle θ relative to the first direction D1 is a main line direction.

The sub-line Ls has a linear shape extending from the second main endpoint Pm2 to a sub-endpoint Ps along a direction perpendicular to the main line Lm, and has half the length of the main line Lm. When the length of the sub-line Ls is a unit length LRP, the length of the main line Lm is 2LRP. A sub-endpoint Ps corresponds to the first main endpoint Pm1 of another reference pattern element 31RP disposed in the main line direction of the sub-line Ls, with respect to the sub-line Ls having the sub-endpoint Ps.

Each reference pattern element 31RP further includes two auxiliary lines La. Each of the two auxiliary lines La has a linear shape extending along the main line direction which is the direction that the main line Lm extends, and has the unit length LRP which is the same length as the sub-line Ls. Of the two auxiliary lines La, one extends from the first main endpoint Pm1 to the first auxiliary endpoint Pa1, and the other one extends from the second main endpoint Pm2 to a second auxiliary endpoint Pa2.

Each reference pattern element 31RP has a shape which conforms to a part of the lattice pattern, and one side of a lattice unit forming the lattice pattern has the same length as the sub-line Ls having the unit length LRP. That is, each reference pattern element 31RP is in a shape conforming to a two-dimensional lattice pattern in which the main line Lm and the auxiliary lines La form a side extending along the main line direction, and the sub-line Ls forms a side extending along a direction perpendicular to the main line Lm. The two-dimensional lattice pattern has a shape wherein a square as a lattice unit is repeatedly formed two-dimensionally.

When the plurality of drive electrodes 31DP overlap three-dimensionally with the plurality of sensing electrodes 33SP sandwiching the transparent dielectric substrate 33, the first main endpoints Pm1, the second main endpoints Pm2, the sub-endpoints Ps, the first auxiliary endpoints Pa1, and the second auxiliary endpoints Pa2 are positioned on the lattice points of the lattice pattern. Therefore, while the reference pattern element 31RP of the drive electrode 31DP and the reference pattern element 33RP of the sensing electrode 33SP have a point where they intersect with each other, there are no line segments constituting the same side of the square lattice.

As shown in FIG. 20, a sensing electrode 33SP is an assembly of a plurality of sensing electrode lines 51. The plurality of sensing electrode lines 51 are arranged at equal intervals along the second direction D2, and each of the plurality of sensing electrode lines 51 extends along the first direction D1. Each sensing electrode line 51 is formed of a plurality of reference pattern elements 33RP whose reference direction is the second direction D2, and the plurality of reference pattern elements 33RP are arrayed along the first direction D1 in the sensing electrode lines 51.

In the touch sensor electrode 21, a lattice pattern is formed in a portion where the drive electrode 31DP and the sensing electrode 33SP overlap three-dimensionally, in plan view perpendicular to the sensing surface 33S. In the lattice pattern, a square having the length LPR on a side is repeatedly formed two-dimensionally. In the touch sensor electrode 21 described in the first embodiment, the portion where the drive electrode 31DP three-dimensionally overlaps with the sensing electrode 33SP is a cell 21C. In the touch sensor electrode 21 described in the second embodiment, the portion where the drive electrode 31DP three-dimensionally overlaps with the sensing electrode 33SP is the portion where the drive connection unit 31DPb overlaps with the sensing connection unit 33SPb.

<Second Modification>

The configuration of the auxiliary line La in each reference pattern element 31RP on the drive surface 31S may be different from that of the auxiliary line La in each reference pattern element 33RP on the sensing surface 33S. In short, each of the reference pattern elements 31RP on the drive surface 31S and each of the reference pattern elements 33RP on the sensing surface 33S only have to include the aforementioned main line Lm and sub-line Ls. In this case, the number of auxiliary lines La included in the reference pattern element 31RP on the drive surface 31S may be different from that of auxiliary lines La included in the reference pattern element 33RP on the sensing surface 33S. Further, the positions of the auxiliary lines La relative to the reference pattern element 31RP on the drive surface 31S may be different from those of the auxiliary lines La relative to the reference pattern element 33RP on the sensing surface 33S.

Basically, the drive electrode lines and the sensing electrode lines may have a complementary relationship for forming a lattice pattern in plan view perpendicular to the transparent dielectric substrate, and may have different reference pattern elements than each other as far as the reference pattern elements each include the main line and the sub-line.

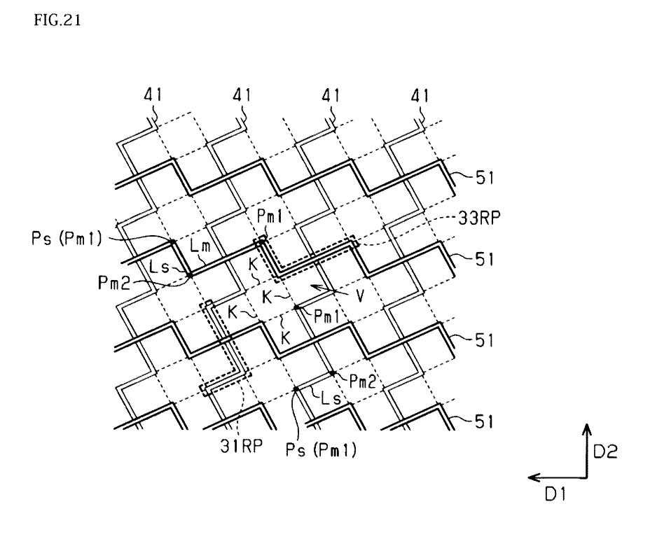

In detail, as shown in FIG. 21, the reference pattern element 31RP and the reference pattern element 33RP are each formed of one main line Lm and one sub-line Ls. In this case, an electrode line space V, which is an area surrounded by two drive electrode lines 41 adjacent in the first direction D1 and two sensing electrode lines 51 adjacent in the second direction D2, is formed in plan view perpendicular to the transparent dielectric substrate. The electrode line space V is in a cross shape formed of five lattice units. One lattice unit positioned at the center of the electrode line space V is sandwiched by other lattice squares from both sides in the first direction D1 and both sides in second direction D2.

The first main endpoint Pm1 in one of the drive electrode lines 41, the second main endpoint Pm2 in the other drive electrode line 41, the first main endpoint Pm1 in one of the sensing electrode lines 51, and the second main endpoint Pm2 in the other sensing electrode line 51 are positioned at the lattice points of the lattice unit located at the center of the electrode line space V. Moreover, in the lattice unit surrounded by the four main endpoints, four auxiliary line areas K are set as areas in each of which at least either an auxiliary line of the drive electrode lines 41 or an auxiliary line of the sensing electrode lines 51 can reside.

The auxiliary lines La of the reference pattern elements 31RP on the drive surface 31S and the auxiliary lines La of the reference pattern elements 33RP on the sensing surface 33S may be determined so as to extend to the auxiliary line areas K from at least one of the four main endpoints and define the four auxiliary line areas K.

The configuration of the auxiliary lines set in the four auxiliary line areas K may be the same or different between the electrode line spaces V. In a configuration where the configuration of the auxiliary lines set in the four auxiliary line areas K is different between electrode line spaces V, the configuration of the auxiliary lines is not repeated for every electrode line space V, and thus such auxiliary lines are not included in the reference pattern elements 31RP and 33RP.

<Third Modification>

The drive electrode lines in the drive detection unit 31DPa may each be mainly formed of the reference pattern elements 31RP similar to the drive electrode lines in the drive connection unit 31DPb. In this case, a sensing dummy part 33SD including a plurality of sensing dummy lines can be disposed on the sensing surface 33S. The sensing dummy part 33SD is disposed between the sensing electrodes 33SP adjacent to each other on the sensing surface 33S, and arranged apart from the sensing electrode 33SP. The sensing dummy part 33SD is an example of the second dummy part, and the sensing dummy line is an example of the second dummy line. Moreover, the drive electrode lines disposed in the drive detection unit 31DPa and the sensing dummy lines have a complementary relationship so as to form a lattice pattern thereby, in plan view perpendicular to the transparent dielectric substrate.

The sensing electrode lines in the sensing detection unit 33SPa may each be mainly formed of the reference pattern elements 33RP, similar to the sensing electrode lines in the sensing connection unit 33SPb. In this case, a drive dummy part including a plurality of drive dummy lines can be disposed on the drive surface 31S. The drive dummy part is disposed between the drive electrodes 31DP adjacent to each other in the drive surface 31S, and arranged apart from the drive electrode 31DP. The drive dummy part is an example of the first dummy part, and the drive dummy line is an example of the first dummy line. Moreover, the sensing electrode lines disposed in the sensing detection unit 33SPa and the drive dummy lines have a complementary relationship so as to form a lattice pattern thereby, in plan view perpendicular to the transparent dielectric substrate.

For example, the touch sensor electrode having both of the drive dummy part and the sensing dummy part are embodied as follows.

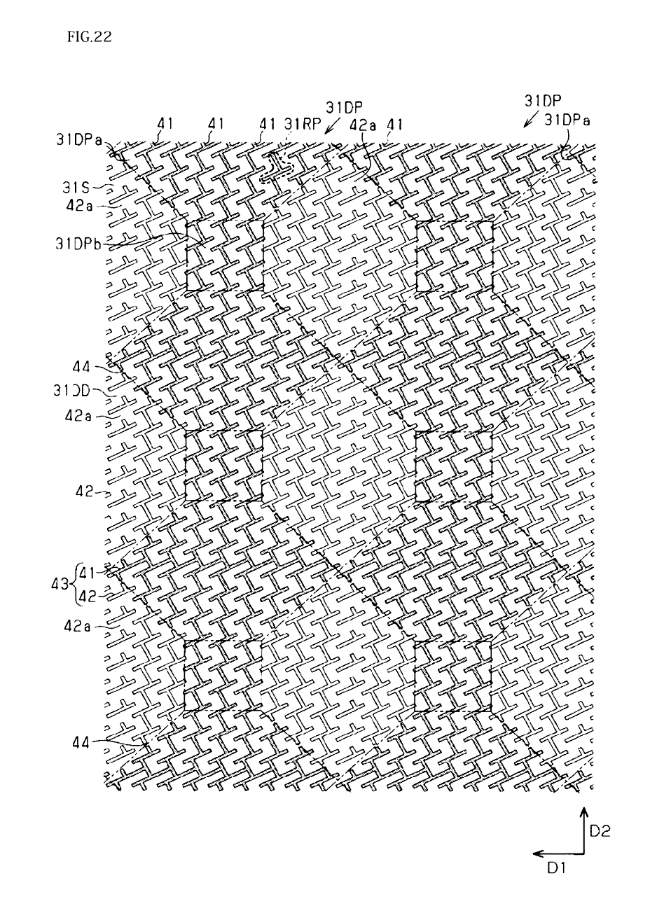

As shown in FIG. 22, the drive detection unit 31DPa has nine drive electrode lines 41 arrayed equally spaced along the first direction D1. Each drive electrode line 41 is mainly formed of the reference pattern elements 31RP, and is extended along the second direction D2. The drive connection unit 31DPb has three drive electrode lines 41 arrayed at equal intervals along the first direction D1. Each drive electrode line 41 is also mainly formed of the reference pattern elements 31RP and extended along the second direction D2.

Among the nine drive electrode lines 41 forming the drive detection unit 31DPa, the three drive electrode lines 41 disposed in the center of the first direction D1 are respectively connected to the three drive electrode lines 41 which form the drive connection unit 31DPb. Therefore, in one drive electrode 31DP, the three drive electrode lines 41 which continuously extend along the second direction D2 are disposed at the center of the first direction D1.

The drive dummy part 31DD is located between two drive electrodes 31DP adjacent in the first direction D1. The drive dummy part 31DD is located between the two successive drive detection units 31DPa in one of the drive electrodes 31DP and the two successive drive detection units 31DPa in the other drive electrode 31DP.

The drive dummy part 31DD, for example, includes six drive dummy lines 42 arrayed equally spaced along the first direction D1, and each drive dummy line 42 extends along the second direction D2. Similarly to the drive electrode lines 41, each drive dummy line 42 includes a plurality of reference pattern elements 31RP having a pattern determined with reference to the first direction D1.

The width along the second direction D2 of the six drive dummy lines 42 is the greatest in the two drive dummy lines 42 located at the center in the first direction D1, and becomes smaller towards the ends of the drive dummy part 31DD in the first direction D1. Two drive dummy lines 42 located sandwiching the two drive dummy lines 42 located at the center in the first direction D1, that is, two drive dummy lines 42 equally distanced from the center in the first direction D1, have a length along the second direction D2 equal to each other. Further, the four drive dummy lines 42, which are different than the two drive dummy lines 42 located at the center in the first direction D1, have a length along the second direction D2 which is smaller by the same length at both ends in the second direction D2, than the drive dummy line 42 located at the center. Thus, the outer shape of the drive dummy part 31DD defined by the ends of the drive dummy lines 42 of the drive dummy part 31DD is in a hexagonal shape.

Among the drive dummy lines 42 included in one drive dummy part 31DD, one of the drive dummy lines 42 located at the center in the first direction D1 has a plurality of dummy internal spaces 42a which are arrayed at equal intervals along the second direction D2. The plurality of dummy internal spaces 42a are provided along the first direction D1 and the second direction D2 for each drive dummy part 31DD.

The drive dummy parts 31DD and parts of the respective drive detection units 31DPa are alternately arranged in series in the second direction D2. In parts of the drive surface 31S, the drive dummy lines 42 forming the drive dummy parts 31DD and the drive electrode lines 41 forming the drive detection units 31DPa are alternately arranged in series in the second direction D2. The plurality of drive electrode lines 41 and the plurality of drive dummy lines 42 alternated in series in the second direction D2 configure a drive pattern group 43. In the drive pattern group 43, a drive electrode line 41 and a drive dummy line 42 adjacent to each other in the second direction D2 share a part of a reference pattern element 31RP.

In the drive pattern group 43, a drive space 44 is provided between an end of a drive electrode line 41 and an end of a drive dummy line 42 in the second direction D2. The drive space 44 separates the drive electrode line 41 and the drive dummy line 42 from each other. The drive dummy part 31DD is apart from the drive electrode 31DP thereby.

Of the aforementioned metals, the material for forming the drive electrode line 41 and the drive dummy line 42 is copper, for example. In plan view perpendicular to the sensing surface 33S, the drive electrode lines 41 and the drive dummy lines 42 have the same hue, e.g., a black color.

The drive electrode line 41 and the drive dummy line 42 are imparted with a black color through blackening treatment given to a metallic thin film for forming these lines. Alternatively, the drive electrode lines 41 and the drive dummy line 42 can be imparted with a black color by being subjected to blackening treatment. Examples of the blackening treatment include an oxidation treatment or a plating treatment for plating a metal film having a black color, and the like.

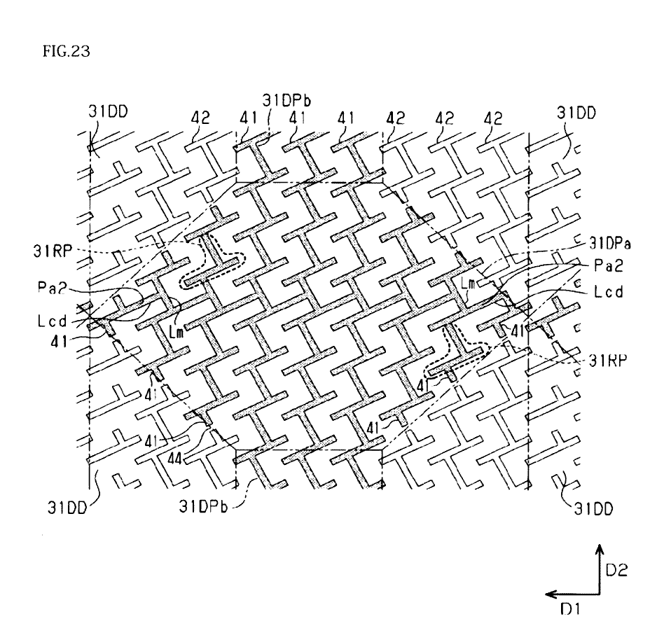

As shown in FIG. 23, each drive electrode line 41 provided to the drive detection unit 31DPa is formed of a plurality of reference pattern elements 31RP arrayed along the second direction D2, and the plurality of drive electrode lines 41 are arrayed along the first direction D1.

In the drive detection unit 31DPa, the drive electrode lines 41 connected to the respective drive electrode lines 41 forming the drive connection unit 31DPb are connected to the pad 31P provided to the drive electrode 31DP. On the one hand, when the drive electrode lines 41 located separately from those forming the drive connection unit 31DPb each include and are formed of only a plurality of reference pattern elements 31RP, such drive electrode lines 41 cannot be electrically connected to the pad 31P provided to the drive electrode 31DP. In this regard, the drive detection unit 31DPa includes the drive connection line Lcd having the same length as the sub-line Ls as a part of a drive electrode line 41. In this case, the drive connection line Lcd electrically connects two drive electrode lines 41 adjacent in the first direction D1.

The drive connection line Lcd extends from the second auxiliary endpoint Pa2 of a reference pattern element 31RP of one drive electrode line 41, to the midpoint of the main line Lm in the main line direction of a reference pattern element 31RP in the drive electrode line 41 adjacent the first direction D1.

Eight drive connection lines Lcd arrayed along the first direction D1 in a drive detection unit 31DPa form a drive connection line group. The drive connection line groups are disposed, along the second direction D2, in respective drive detection units 31DPa.

The drive electrode lines 41 configuring a drive electrode 31DP and the drive dummy lines 42 may be formed by etching a thin film, via a mask, which is formed on the drive surface 31S, or may be formed by physical vapor deposition, e.g. vacuum vapor deposition or sputtering, using a mask.

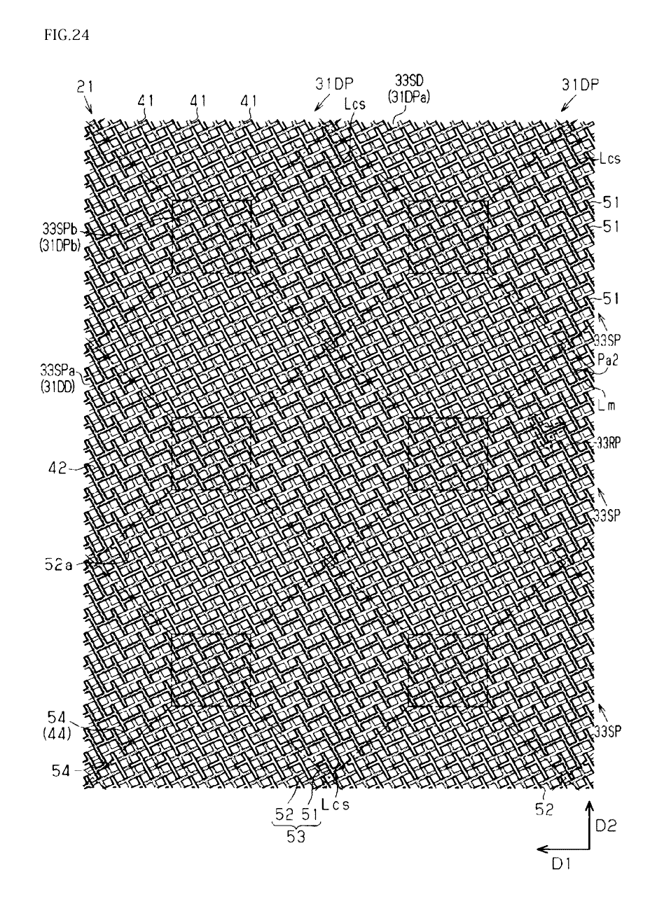

With reference to FIG. 24, a configuration of the touch sensor electrode of a third modification will be described. In FIG. 24, for convenience of description of the arrangement of a plurality of drive electrode lines forming the drive electrode 31DP and the arrangement of a plurality of sensing electrode lines forming the sensing electrode 33SP, the width of the drive electrode lines and the width of the sensing electrode lines are illustrated in an exaggerated manner.

As shown in FIG. 24, the sensing detection unit 33SPa has nine sensing electrode lines 51 arrayed at equal intervals along the second direction D2. Each sensing electrode line 51 is mainly formed of the reference pattern element 33RP, and extends along the first direction D1. The sensing connection unit 33SPb has three sensing electrode lines 51 arrayed at equal intervals along the second direction D2. Each sensing electrode line 51 is also mainly formed of the reference pattern element 33RP and extends along the first direction D1.

Of the nine sensing electrode lines 51 forming the sensing detection unit 33SPa, the three sensing electrode lines 51 located at the center in the second direction D2 are respectively connected to the three sensing electrode lines 51 configuring the sensing connection unit 33SPb. Thus, in the sensing electrode 33SP, the three sensing electrode lines 51 extending successively along the first direction D1 are located at the center in the second direction D2.

In the sensing detection unit 33Spa, the sensing electrode lines 51 connected to the respective sensing electrode lines 51 forming the sensing connection unit 33SPb are connected to the pad 33P provided to the sensing electrode 33SP. On the one hand, when the sensing electrode lines 51 separated from those forming the sensing connection unit 33SPb each include and are formed of only a plurality of reference pattern elements 33RP, such sensing electrode lines 51 cannot be electrically connected to the pad 33P provided to the sensing electrode 33.

Therefore, the sensing detection unit 33SPa includes the sensing connection line Lcs having the same length as the sub-line Ls. The sensing connection line Lcs electrically connects between two sensing electrode lines 51 adjacent in the second direction D2.

The sensing connection line Lcs extends from the second auxiliary endpoint Pa2 of a reference pattern element 33RP of one sensing electrode line 51, to the midpoint of the main line Lm in the main line direction of a reference pattern element 31RP in the sensing electrode line 51 adjacent in the second direction D2. In plan view perpendicular to the sensing surface 33S, the sensing connection lines Lcs overlap with mutually different dummy internal spaces 42a located on the drive surface 31S.

In the sensing detection unit 33SPa, eight sensing connection lines Lcs arrayed along the second direction D2 form a sensing connection line group. The sensing connection line groups are located in the respective sensing detection units 33SPa along the first direction D1.

The sensing dummy part 33SD is disposed between two sensing electrodes 33SP adjacent in the second direction D2. The sensing dummy part 33SD is disposed between two sensing detection units 33SPa in one of sensing electrode 33SP and the two sensing detection units 33SPa in the other sensing electrode 33SP.

The sensing dummy part 33SD is formed of, for example, six sensing dummy lines 52 a at equal intervals along the second direction D2, and each sensing dummy line 52 extends along the first direction D1. Each sensing dummy line 52 includes a plurality of reference pattern elements 33RP having a pattern determined with reference to the second direction D2.

The width along the first direction D1 of the six sensing dummy lines 52 is the greatest in the two sensing dummy lines 52 disposed at the center in the second direction D2, and becomes smaller towards the ends in the second direction D2. Two sensing dummy lines 52 disposed sandwiching the two sensing dummy lines 52 at the center in the second direction D2, that is, two sensing dummy lines 52 equally distanced from the center in the second direction D2, are equal in the length along the first direction D1. Further, the four sensing dummy lines 52 which are different than the two sensing dummy lines 52 located at the center in the second direction D2 each have a length along the first direction D1 smaller by the same length at both ends in the first direction D1 than the sensing dummy lines 52 located at the center. Thus, the outer shape of the sensing dummy part 33SD defined by the ends of the sensing dummy lines 52 in the sensing dummy part 33SD is in a hexagonal shape.

Of the sensing dummy lines 52 included in the sensing dummy part 33SD, one of the sensing dummy lines 52 located at the center in the second direction D2 has a plurality of dummy internal spaces 52a which are arrayed at equal intervals along the first direction D1. The plurality of dummy internal spaces 52a are provided, along the first direction D1 and second direction D2, for each sensing dummy part 33SD. In plan view perpendicular to the sensing surface 33S, the dummy internal spaces 52a on the sensing surface 33S are overlapped with respective mutually different drive connection lines Lcd.

In the first direction D1, the sensing dummy parts 33SD and parts of the respective sensing detection units 33SPa are alternately arranged in series. In parts of the touch sensor electrode 21, the sensing dummy lines 52 forming the sensing dummy parts 33SD and the sensing electrode lines 51 forming the sensing detection units 33Spa are alternately arranged in series in the first direction D1. The sensing electrode lines 51 and the sensing dummy lines 52 alternated in series in the first direction D1 form a sensing pattern group 53. In the sensing pattern group 53, a sensing electrode line 51 and a sensing dummy line 52 adjacent to each other in the first direction D1 share a part of a reference pattern element 33RP.

In the sensing pattern group 53, a sensing space 54 is formed between an end of a sensing electrode line 51 and an end of a sensing dummy line 52 in the first direction D1. The sensing space 54 separates the sensing electrode line 51 and the sensing dummy line 52 from each other. Thus, the sensing dummy parts 33SD are separated from the sensing electrodes 33SP.

Parts of the plurality of the sensing spaces 54 overlap three-dimensionally with the drive space 44 in plan view perpendicular to the sensing surface 33S.

Of the aforementioned metals, the forming material for the sensing electrode lines 51 and the sensing dummy line 52 is copper, for example. In plan view perpendicular to the sensing surface 33S, the sensing electrode lines 51 and the sensing dummy line 52 have the same hue, e.g. a black color.

The sensing electrode lines 51 and the sensing dummy lines 52 are imparted with a black color through black oxide treatment given to a metallic thin film for forming these lines. Alternatively, the sensing electrode lines 51 and the sensing dummy line 52 can be imparted with a black color by being subjected to blackening treatment. Examples of the blackening treatment include an oxidation treatment or a plating treatment for plating a metal film having a black color, and the like.

Typically, the blackening treatment to the sensing electrode lines 51 and the sensing dummy lines 52 is performed at a time point different from the blackening treatment to the drive electrode lines 41 and the drive dummy lines 42. Therefore, in many cases, at least one of brightness and saturation in the black color of the sensing electrode lines 51 and the sensing dummy lines 52 is different from at least one of brightness and saturation in the black color of the drive electrode lines 41 and the drive dummy lines 42.

Further, when the touch sensor electrode 21 is viewed, the drive electrode lines 41 and the drive dummy lines 42 are viewed via the transparent dielectric substrate 33. Therefore, in many cases, the color of the drive electrode lines 41 and the drive dummy lines 42 is visually recognized as a color different from the color of the sensing electrode lines 51 and the sensing dummy lines 52.

In the touch sensor electrode 21, the drive detection unit 31DPa overlaps three-dimensionally with the sensing dummy part 33SD located between two sensing electrodes 33SP adjacent to each other, in plan view perpendicular to the sensing surface 33S.

Therefore, in plan view perpendicular to the sensing surface 33S, the drive electrode lines 41 of the drive detection unit 31DPa and the sensing dummy lines 52 of the sensing dummy part 33SD form a square lattice formed of the reference pattern elements 31RP and 33RP. In short, in a drive part 21D of a common single lattice pattern, the drive electrode lines 41 of the drive detection unit 31DPa and the sensing dummy lines 52 of the sensing dummy part 33SD form separate line segments which intersect with each other.

On the one hand, in the touch sensor electrode 21, the sensing detection unit 33SPa overlaps three-dimensionally with the drive dummy part 31DD located between two drive electrodes 31DP adjacent to each other, in plan view perpendicular to the sensing surface 33S.

Therefore, in plan view perpendicular to the sensing surface 33S, the sensing electrode lines 51 of the sensing detection unit 33SPa and the drive dummy lines 42 of the drive dummy part 31DD form a square lattice formed of the reference pattern elements 31RP and 33RP. In short, in a sensing part 21S of the previous lattice pattern, the sensing electrode lines 51 of the sensing detection unit 33SPa and the drive dummy lines 42 of the drive dummy part 31DD form separate line segments intersecting with each other.

Further, the drive connection unit 31DPb overlaps three-dimensionally with the sensing connection unit 33SPb in plan view perpendicular to the sensing surface 33S. Therefore, in plan view perpendicular to the sensing surface 33S, the drive electrode lines 41 of the drive connection unit 31DPb and the sensing electrode lines 51 of the sensing connection unit 33SPb form a square lattice that is formed of the reference pattern elements 31RP and 33RP. In short, the drive electrode lines 41 of the drive connection unit 31DPb and the sensing electrode lines 51 of the sensing connection unit 33SPb form separate line segments intersecting with each other in a part different from the drive part 21D and the sensing part 21S in the previous lattice pattern.

Therefore, in plan view perpendicular to the transparent dielectric substrate, in a part of the lattice pattern, of the four line segments forming a lattice unit, two line segments are a part of a drive electrode line 41, and two line segments are a part of a sensing dummy line 52. Further, in a part of the lattice pattern, of the four line segments forming the lattice unit, two line segments are a part of a sensing electrode line 51, and two line segments are a part of a drive dummy line 42. As a result, the configuration of the drive detection unit 31DPa and that of the sensing detection unit 33SPa are unlikely to be individually visually recognized in plan view perpendicular to the transparent dielectric substrate.

In the third modification, the plurality of drive dummy lines 42 may be or may not be formed of the reference pattern elements 31RP. Further, the plurality of the sensing dummy lines 52 may be or may not be formed of the reference pattern elements 33RP. Basically, in plan view perpendicular to the transparent dielectric substrate, the drive electrode lines and the sensing dummy lines disposed in the drive detection unit 31DPa only need to have a complementary relationship so as to form a lattice pattern thereby. Further, the sensing electrode lines and the drive dummy lines disposed in the sensing detection unit 33SPa only need to have a complementary relationship so as to form a lattice pattern.

Further, in plan view perpendicular to the transparent dielectric substrate, of the four line segments forming a lattice unit of the lattice pattern, two line segments are a part of a drive electrode line 41, and two line segments are a part of a sensing dummy line 52. In plan view perpendicular to the transparent dielectric substrate, of the four line segments forming a lattice unit of the lattice pattern, two in line segments are a part of a sensing electrode line 51, and two line segments are a part of a drive dummy line 42.

While not limited thereto, the lattice pattern may include a lattice unit in which, of the four line segments, three are a part of a drive electrode line 41 and one is a part of a sensing dummy line 52. Further, the lattice pattern may include a lattice unit in which one line segment is a part of a drive electrode line 41, and three line segments are a part of a sensing dummy line 52.

Further, the lattice pattern may include a lattice unit in which, of the four line segments, three are a part of a sensing electrode line 51 and one is a part of a drive dummy line 42. Further, the lattice pattern may include a lattice unit in which one line segment is a part of a sensing electrode line 51 and three line segments are a part of a drive dummy line 42.

With this configuration as well, the aforementioned advantages can be obtained as far as a lattice unit includes a part of a drive electrode line 41 and a part of a sensing dummy line 52, and a lattice unit includes a part of a sensing electrode line 51 and a part of a drive dummy line 41.

In the third modification, the drive electrode lines 41, the drive dummy lines 42, the sensing electrode lines 51 and the sensing dummy lines 52 do not need to have a black color. For example, the drive electrode lines 41, the drive dummy lines 42, the sensing electrode lines 51 and the sensing dummy lines 52 may be configured to have a metallic luster or optical transparency. In this case, usable forming materials of the electrode lines having optical transparency in include a metal oxide film such as of zinc oxide; and a complex oxide film containing a metal oxide such as indium tin oxide or indium gallium zinc oxide of indium, tin, gallium and zinc. A silver nanowire or an electrically conductive polymer film can also be used for the electrode lines having a metallic luster, in addition to the aforementioned metal films. Further, the electrode lines having a black color are not limited to metal wires subjected to a blackening treatment, and an electrically conductive film such as a graphene film can also be used.

With this configuration as well, the color of the drive electrode 31DP is different from the color of the sensing electrode 33SP when viewed from the surface of the transparent dielectric substrate 33, because the transparent dielectric substrate 33 is disposed between the drive electrode 31DP and the sensing electrode 33SP. Therefore, advantages similar to those of the third modification are obtained.

Further, in the third modification, the drive electrode 31DP and the drive dummy part 31DD, in plan view perpendicular to the sensing surface 33S, may have the same color attributes, and the sensing electrode 33SP and the sensing dummy part 33SD may have color attributes different from the drive electrode 31DP. The color attributes include three properties of hue, brightness, and, saturation. Therefore, while all of the three color properties are the same between the drive electrode 31DP and the drive dummy part 31DD, at least one among the three color properties of the sensing electrode 33SP and the sensing dummy part 33SD is different from that of the drive electrode 31DP. This configuration can also obtain advantages similar to those of the third modification.

Further, in the third modification, the drive electrode 31DP, the drive dummy part 31DD, the sensing electrode 33SP, and the sensing dummy part 33SD may have the same color attributes. With this configuration as well, the transparent dielectric substrate 33 is intervened between the drive electrode 31DP and the drive dummy part 31DD, and the sensing electrode 33SP and the sensing dummy part 33SD. Therefore, the color of the drive electrode 31DP and the drive dummy part 31DD can be different from the color of the sensing electrode 33SP and the sensing dummy part 33SD in plan view perpendicular to the sensing surface 33S. Therefore, advantages similar to those of the third modification can be obtained.

Further, in the third modification, in two drive electrode lines 41 adjacent to each other, the drive connection line Lcd does not necessarily need to be configured so as to extend from the second auxiliary endpoint Pa2 of the reference pattern element 31RP of one drive electrode line 41 towards the center of the main line Lm, in the main line direction, of the other drive electrode line 41. For example, in two drive electrode lines 41 adjacent to each other, the drive connection line Lcd may extend along the extension direction from the second auxiliary endpoint Pa2 of the reference pattern element 31RP of one drive electrode line 41 towards the first main endpoint Pm1 of the other drive electrode line 41. Basically, the drive connection line Lcd only has to be a straight line having the unit length LRP and extending along the main line direction or along a direction perpendicular to the main line direction, and only has to connect two drive electrode lines 41 adjacent to each other in a drive detection unit 31DPa.

Further, in the third modification, in two sensing electrode lines 51 adjacent to each other, the sensing connection line Lcs does not necessarily need to be configured so as to extend from the second auxiliary endpoint Pa2 of the reference pattern element 33RP of one sensing electrode line 51 towards the center of the main line Lm, in the main line direction, of the other sensing electrode line 51. Basically, the sensing connection line Lcs only has to be a straight line having the unit length LRP and extending along the main line direction or a direction perpendicular to the extension direction, and only has to connect two sensing electrode lines 51 adjacent to each other in a sensing detection unit 33SPa.

The third modification and equivalent configurations thereof can be implemented in combination with the configurations of the first and second modifications.

<Fourth Modification>

In plan view perpendicular to the transparent dielectric substrate, a detection unit space, or a gap, may be formed between the drive detection unit 31DPa and the sensing detection unit 33SPa adjacent to each other. In this case, in the lattice pattern in plan view perpendicular to the transparent dielectric substrate, a drive dummy part positioned in the detection unit space may serve as the detection unit space, or a sensing dummy part may serve as the detection unit space, or a drive dummy part and a sensing dummy part may be complementarily serve as the detection unit space.

For example, the following is an embodiment of a touch sensor electrode in which a drive dummy part and a sensing dummy part positioned in a detection unit space in a lattice pattern 11) complementarily serve as the detection unit space.

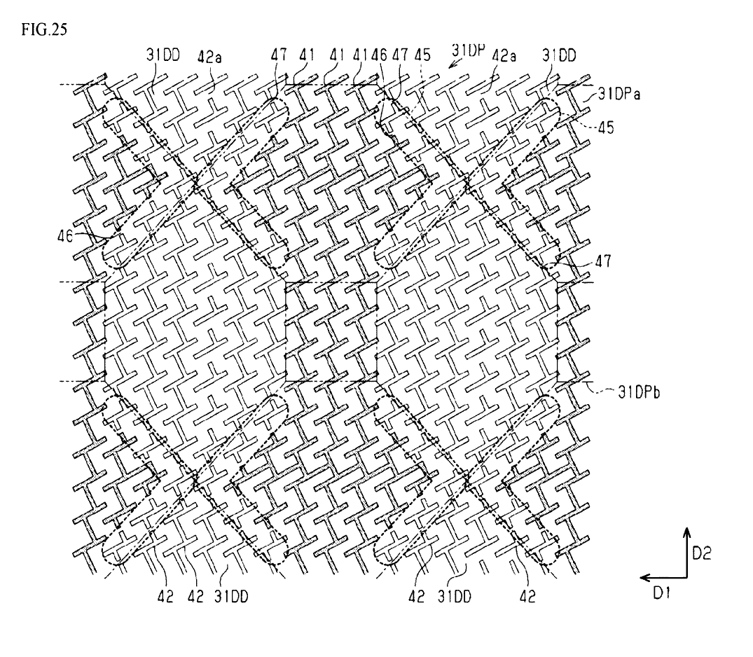

As shown in FIG. 25, one drive electrode 31DP is formed of a plurality of the drive detection units 31DPa arranged along the second direction D2, and drive connection unit 31DPb each connected between two drive detection units 31DPa adjacent to each other. A plurality of drive electrodes 31DP are arrayed along the first direction D1.

Detection unit spaces 45 are disposed between two drive detection units 31DPa adjacent in the first direction D1. The detection unit spaces 45 extend along the outer rims of the drive detection units 31DPa in the first direction D1. In each detection unit space 45, that is a part of a drive dummy part 31DD, a plurality of drive dummy lines 42 are disposed.

In plan view perpendicular to the sensing surface 33S, the portion except for the detection unit spaces 45 in a drive dummy part 31DD faces a sensing detection unit 33SPa. Thus, the detection unit space 45 is a space formed between the drive detection unit 31DPa and the sensing detection unit 33SPa in the first direction D1.

Each of the drive dummy lines 42 located in the detection unit space 45 is spaced apart from a drive electrode line 41 by, for example, an electrode line space 46 provided between the drive electrode lines 41 and the drive dummy line 42. The drive dummy line 42 which is located in the detection unit space 45 is further spaced apart from a part of the drive dummy line 42 by a dummy line space 47 provided inside the drive dummy part 31DD. The dummy line space 47 may be omitted.

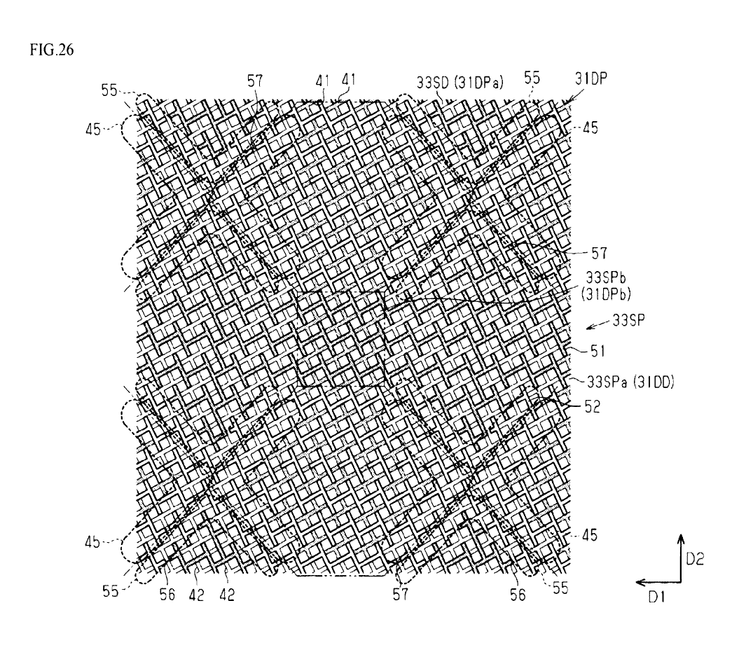

With reference to FIG. 26, a configuration of the touch sensor electrode of the fourth modification will be described. In FIG. 26, for convenience of describing the arrangement of a plurality of drive electrode lines forming a drive electrode 31DP and the arrangement of a plurality of sensing electrode lines forming a sensing electrode 33SP, the width of the drive electrode lines and the width of the sensing electrode lines are illustrated in an exaggerated manner.

As shown in FIG. 26, a sensing electrode 33SP is formed of a plurality of the sensing detection units 33SPa arranged along the first direction D1 and sensing connection units 33SPb each connecting between two sensing detection units 33SPa adjacent to each other. A plurality of sensing electrodes 33SP are arrayed along the second direction D2.

Detection unit spaces 55 are disposed between two sensing detection units 33SPa adjacent in the second direction D2. The detection unit spaces 55 extend along the outer rims of the sensing detection units 33SPa in the second direction D2. In each detection unit space 55, that is a part of a sensing dummy part 33SD, a plurality of sensing dummy lines 52 are disposed.

In plan view perpendicular to the sensing surface 33S, a portion except for the detection unit spaces 55 in a sensing dummy part 33SD faces a drive detection unit 31DPa. Thus, the detection unit space 55 is a space formed between the sensing detection unit 33SPa and the drive detection unit 31DPa in the second direction D2.

Each of the sensing dummy lines 52 located in a detection unit space 55 is spaced apart from a sensing electrode line 51 by an electrode line space 56 provided, for example, between the sensing electrode line 51 and the sensing dummy line 52. The sensing dummy line 52 located in the detection unit space 55 is further spaced apart from a part of the sensing dummy line 52 by a dummy line space 57 provided inside the sensing dummy part 33SD. The dummy line space 57 may be omitted.

In the touch sensor electrode 21, in plan view perpendicular to the sensing surface 33S, the drive detection unit 31DPa faces a portion except for the detection unit spaces 55 in the sensing dummy parts 33SD, and the sensing detection unit 33SPa faces a portion except for the detection unit spaces 45 in the drive dummy parts 31DD.

Therefore, in plan view perpendicular to the sensing surface 33S, the detection unit space 45 on the drive surface 31S and the detection unit space 55 on the sensing surface 33S are formed between the drive detection unit 31DPa and the sensing detection unit 33SPa adjacent in the first direction D1. Therefore, in plan view perpendicular to the sensing surface 33S, the drive detection unit 31DPa and the sensing detection unit 33SPa adjacent to each other are spaced apart from each other in the first direction D1 by the amount of the two detection unit spaces 45 and 55, and are spaced apart from each other in the second direction D2 by the amount of the two detection unit spaces 45 and 55.

In the touch sensor electrode 21, the detection unit space 45 is formed between the drive detection unit 31DPa and the sensing detection unit 33SPa on the drive surface 31S, and the detection unit space 55 is formed between the drive detection unit 31DPa and the sensing detection unit 33SPa on the sensing surface 33S.

Therefore, the electric field formed between the drive detection 11) unit 31DPa and the sensing detection unit 33SPa is easily influenced from outside the transparent dielectric substrate 33. Therefore, the accuracy for detecting the position of a finger increases with respect to the touch sensor electrode 21.

Part of the drive dummy part 31DD is located in the detection unit space 45 on the drive surface 31S, and the sensing dummy part 33SD is located in the detection unit space 55 on the sensing surface 33S. Therefore, in a configuration where a detection unit space is formed in the touch sensor electrode 21, the drive electrode 31DP and the sensing electrode 33SP are prevented from being visually recognized as being separate structures.

Further, on the drive surface 31S, the detection unit space 45 is formed between the drive detection unit 31DPa and the sensing detection unit 33Spa, and on the sensing surface 33S, the detection unit space 55 is formed between the drive detection unit 31DPa and the sensing detection unit 33SPa.

Therefore, the magnitude of the electrostatic capacitance between the drive detection unit 31DPa and the sensing detection unit 33SPa changes more compared to the configuration in which a part of the drive detection unit 31DPa is located in the detection unit space 45, and a part of the sensing detection unit 33SPa is located in the detection unit space 55. Thus, the electrostatic capacitance between the drive detection unit 31DPa and the sensing detection unit 33SPa can be changed in conformity with the specifications of the control unit 36 to which the touch sensor electrode 21 is connected.

Furthermore, the electrostatic capacitance between the drive electrode 31DP and the sensing electrode 33SP can be changed by only determining the position of the electrode line space 46 on the drive surface 31S and determining the position of the electrode line space 56 on the sensing surface 33S. Therefore, the electrostatic capacitance between the drive electrode 31DP and the sensing electrode 33SP can be changed without having to significantly change the design of the drive electrode 31DP provided to the touch sensor electrode 21 or significantly change the design of the sensing electrode 33SP.

On the drive surface 31S of the fourth modification, a part of the sensing dummy part 31DD is located in each of all the detection unit spaces 45. However, without being limited to this, a part of the drive dummy part 31DD may be located in at least one of the detection unit spaces 45. With such a configuration as well, advantages similar to those of the fourth modification can be obtained as far as the lattice pattern is also formed in the detection unit space.

Part of the sensing dummy part 33SD is located in each of all the detection unit spaces 55 on the sensing surface 33S of the fourth modification. However, without being limited to this, part of the sensing dummy part 33SD may be located in at least one of the detection unit spaces 55. This configuration can also obtain advantages similar to those of the fourth modification as far as the lattice pattern is also formed in the detection unit space.

On the drive surface 31S of the fourth modification, the position of the electrode line space 46 only has to be determined, for example, according to the magnitude of the electrostatic capacitance between the drive detection unit 31DPa and the sensing detection unit 33SPa. The greater the distance is between the electrode line space 46 and the dummy line space 47 closest to the electrode line space 46 in the second direction D2, the smaller the area of the drive detection unit 31DPa becomes. Therefore, the electrostatic capacitance between the drive detection unit 31DPa and the sensing detection unit 33SPa becomes small.

On the sensing surface 33S of the fourth modification, the position of the electrode line space 56 only has to be determined, for example, according to the magnitude of the electrostatic capacitance between the drive detection unit 31DPa and the sensing detection unit 33SPa. The greater the distance is between the electrode line space 56 and the dummy line space 57 closest to the electrode line space 56 in the first direction D1, the smaller the area of the sensing detection unit 33SPa becomes. Therefore, the electrostatic capacitance between the drive detection unit 31DPa and the sensing detection unit 33SPa becomes small.

Of the plurality of sensing detection units 31DPa disposed on the sensing surface 31S of the fourth modification, only some of the drive detection units 31DPa may include the detection unit spaces 45 located on the outer rims thereof. This configuration can also obtain advantages similar to those of the fourth modification in the drive detection units 31DPa adjacent to the detection unit space 45.

Of the plurality of the sensing detection units 33SPa disposed on the sensing surface 33S of the fourth modification, only some of the sensing detection units 33SPa may include the detection unit spaces 55 so as to be located on the outer rims thereof. This configuration can also obtain advantages similar to those of the fourth modification in the sensing detection unit 33SPa adjacent to the detection unit space 55.

While the detection unit space 45 is located on the drive surface 31S in the fourth modification, the detection unit space 55 does not necessarily need to be located on the sensing surface 33S. With this configuration as well, the detection unit space 45 is located between the drive detection unit 31DPa and the sensing detection unit 33SPa in plan view perpendicular to the sensing surface 33S, so that advantages similar to those of the fourth modification can be obtained.

While the detection unit space 55 is located on the sensing surface 33S of the fourth modification, the detection unit space 45 does not necessarily need to be located on the drive surface 31S. With this configuration as well, the detection unit space 55 is located between the drive detection unit 31DPa and the sensing detection unit 33SPa, so that advantages similar to those of the fourth modification can be obtained.

The fourth modification and the equivalent configurations thereof can also be implemented in combination with the configurations of the first, second and third modifications. For example, the drive electrode 31DP may have a belt-like shape as shown in the first embodiment, and the sensing electrode 33SP may have the sensing detection unit 33SPa and the sensing connection unit 33SPb as shown in the second embodiment. In this case, the touch sensor electrode may have only the aforementioned sensing dummy part 33SD, or may further be separately provided with the drive dummy part 31DP so as to fill between the belt-like drive electrodes 31DP.

<Fifth Modification>

The inclination of the plurality of line segments forming the lattice pattern may each be inclined relative to the first and second directions D1 and D2 at an angle set as follows.

An area having a square shape is defined by drive straight lines each passing across two drive electrodes 31DP adjacent to each other and sensing straight lines each passing across two sensing electrodes 33SP adjacent to each other. The square area is set as a unit area. In the first embodiment, the cell 21C corresponds to the unit area. Further, in such a unit area, the reference pattern element 31RP located on one end in the second direction D2 among the plurality of reference pattern elements 31RP of the drive electrode line 31L is set to a first starting point pattern element. Further, the reference pattern element 33RP located on one end in the first direction D1 among the plurality of reference pattern elements 33RP of the sensing electrode line 33L is set to a second starting point pattern element.

Then, the inclination of the lattice pattern is set to satisfy the following conditions. That is, the first starting point pattern elements are successively arrayed along the second direction D2 on a unit-area basis and the second starting point pattern elements are successively arrayed along the first direction D1 on a unit-area basis. Furthermore, the plurality of reference pattern elements 31RP serially connected to the first starting point pattern element extend towards another first starting point pattern element in the unit area adjacent in the second direction D2. Further, the plurality of reference pattern elements 33RP serially connected to the second starting point pattern element extend towards another second starting point pattern element in the unit area adjacent in the first direction D1.

For example, a touch sensor electrode having such a lattice pattern is embodied as follows.

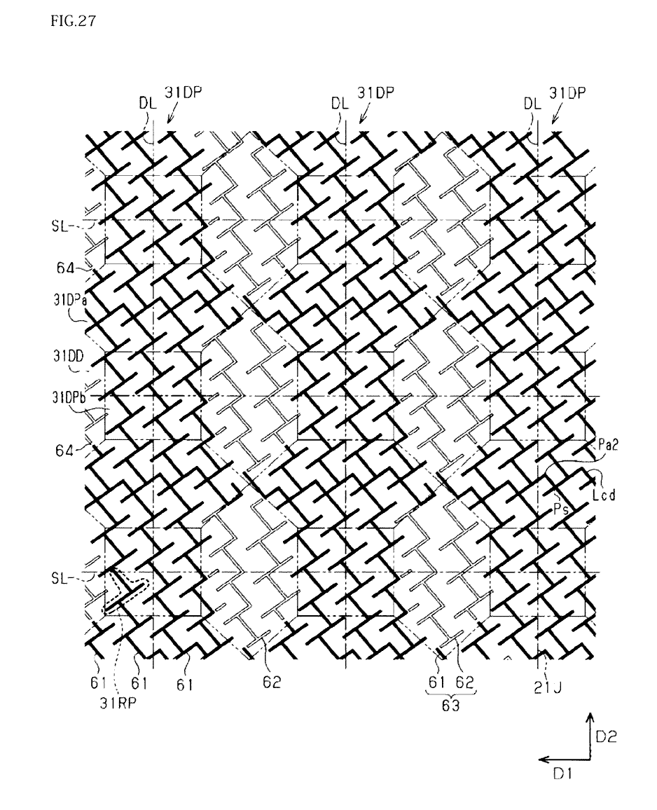

As shown in FIG. 27, the drive detection unit 31DPa has, for example, five drive electrode lines 61 arrayed at equal intervals along the first direction D1, with each drive electrode line 61 extending along the second direction D2. The drive connection unit 31DPb has, for example, three drive electrode lines 61 arrayed at equal intervals along in the first direction D1, with each drive electrode line 61 extending along the second direction D2.

Of the five drive electrode lines 61 forming the drive detection unit 31DPa, the three drive electrode lines 61 successively arrayed in the first direction D1 are respectively connected to the three drive electrode lines 61 forming the drive connection unit 31DPb.

Each of the five drive electrode lines 61 arrayed along the first direction D1 in the drive detection unit 31DPa is connected to the adjacent drive electrode line 61 by the drive connection line Lcd extending along the main line direction.

The drive connection line Lcd extends, for example, from the second auxiliary endpoint Pa2 of the reference pattern element 31RP of one drive electrode line 61 towards the sub-endpoint Ps of the reference pattern element 31RP of the other drive electrode lines 61. Four drive connection lines Lcd in the drive detection unit 31DPa configure a drive connection line group. Such drive connection line groups are formed in the respective drive detection units 31DPa and successively arrayed along the second direction D2.

The drive dummy part 31DD is disposed between the two drive electrodes 31DP adjacent in the first direction D1. The drive dummy part 31DD is disposed between two successive drive detection units 31DPa of one drive electrodes 31DP and two successive drive detection units 31DPa of the other drive electrode 31DP.

The drive dummy part 31DD is formed, for example, of two drive dummy lines 62 arranged at equal intervals along the first direction D1, with each drive dummy line 62 extending along the second direction D2. Each drive dummy line 62 includes a plurality of reference pattern elements 31RP whose reference direction is the first direction D1.

The drive dummy parts 31DD and parts of the drive detection units 31DPa are alternately arrayed in series in the second direction D2. In parts of the drive surface 31S, the drive dummy lines 62 forming the drive dummy parts 31DD and the drive electrode lines 61 forming the drive detection units 31DPa are alternately arrayed in series in the second direction D2. The drive electrode lines 61 and the drive dummy lines 62 alternated in series in the second direction D2 form a drive pattern group 63, while a drive electrode line 61 and a drive dummy line 62 adjacent in the second direction D2 share a part of a reference pattern element 31RP.

In the drive pattern group 63, a drive space 64 is provided between an end of a drive electrode line 61 and an end of a drive dummy line 62 in the second direction D2. The drive space 64 spaces apart the drive electrode line 61 and the drive dummy line 62 from each other. Thus, the drive dummy parts 31DD are separated from the drive electrode 31DP.

In FIG. 27, the straight line passing through the center of each drive electrode 31DP in the first direction D1 and extending along the second direction D2 is a drive straight line DL. Of the drive straight lines DL, two drive straight lines DL adjacent in the first direction D1 define an area therebetween as a drive electrode line area. In contrast, the straight line passing through the center of each sensing electrode 33SP in the second direction D2 and extending along the first direction D1 is a sensing straight lines SL. Of the sensing straight lines SL, two sensing straight lines SL adjacent in the second direction D2 define an area therebetween as a sensing electrode line area.

In plan view perpendicular to the sensing surface 33S, the area in which a drive electrode line area and a sensing electrode line area overlap three-dimensionally is a unit area 21U. The unit areas 21U are provided in series along the first and second directions D1 and D2.

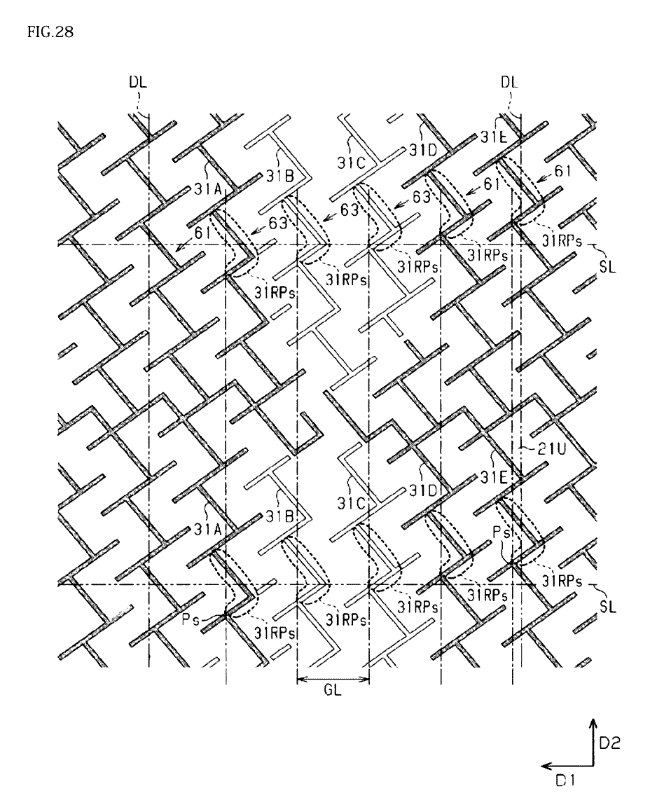

As shown in FIG. 28, two drive electrode lines 61 arranged along the first direction D1 and three drive pattern groups 63 are assigned to each unit area 21U. In each unit area 21U, the drive electrode lines 61 which are located at respective ends in the first direction D1 sandwich the three drive pattern groups 63. The two drive electrode lines 61 and the three drive pattern groups 63 are arranged at equal intervals in the first direction D1.

In each unit area 21U, two drive electrode lines 61 and three drive pattern groups 63 form a drive wiring group. The drive wiring groups provided in the respective unit areas 21U are disposed continuously in the second direction D2.

Each drive electrode line 61 forming a drive wiring group is assigned with five reference pattern elements 31RP, per unit area 21U, arrayed along the second direction D2. Similarly to the drive electrode lines 61, each drive pattern group 63 forming a drive wiring group is assigned with five reference pattern elements 31RP, per unit area 21U, arrayed along the second direction D2. In each of the two drive electrode lines 61 and the three drive pattern groups 63, the reference pattern element 31RP located at an end in the second direction D2 is a starting point pattern element 31RPs. Each starting point pattern element 31RPs in the unit area 21U on the drive surface 31S is an example of the first starting point pattern element.

In a unit area 21U, the distance between two starting point pattern elements 31RPs adjacent in the first direction D1 is a wire space width GL. For example, the distance between the sub-endpoints Ps of the starting point pattern elements 31RPs, the distance being parallel to the distance along the first direction D1, is the wire space width GL.

In each of the drive electrode lines 61 and the drive pattern groups 63, a main line Lm and a sub-line Ls form a reference pattern element 31RP. Further, in a reference pattern elements 31RP, a pattern having a space between the main line Lm and the sub-line Ls, or midway in the main line Lm is also taken to be included in the reference pattern element 31RP.

The drive electrode lines 61 and the drive pattern groups 63 included in a drive wiring group are an A wiring 31A, a B wiring 31B, a C wiring 31C, a D wiring 31D and a E wiring 31E in order from the drive electrode line 61 located at an end of the second direction D2.

In a unit area 21U, the positions of the starting point pattern elements 31RPs in the respective A to E wirings 31A to 31E are determined. The five starting point pattern elements 31RPs configure a starting point pattern element group. The starting point pattern element groups are successively provided along the second direction D2 in the respective unit area 21U. The positions of the starting point pattern elements 31RPs in a unit area 21U are the same between the plurality of unit areas 21U. Thus, in the plurality of unit areas 21U provided in series in the second direction D2, the plurality of starting point pattern elements 31RPs are respectively arrayed along the second direction D2.

A plurality of reference pattern elements 31RP serially connected to the starting point pattern element 31RPs of the B wiring 31B are arrayed so as to extend towards the starting point pattern element 31RPs of the A wiring 31A of the unit area 21U adjacent in the second direction D2. Further, a plurality of reference pattern elements 31RP serially connected to the starting point pattern element 31RPs of the C wiring 31C are arrayed so as to extend towards the starting point pattern element 31RPs of the B wiring 31B of the unit area 21U adjacent in the second direction D2.

That is, a plurality of reference pattern elements 31RP serially connected to a starting point pattern element 31RPs extend towards another starting point pattern element 31RPs whose position in the first direction D1 differs, from the first starting point pattern element 31RPs, by a multiple of 1 of the wire space width GL. Thus, in the unit area 21U, the wirings forming the drive wiring group extend from the respective starting point pattern elements 31RPs towards the respective starting point pattern elements 31RPs of the unit area 21U adjacent in the second direction D2, so as to incline by a multiple of 1 of the wire space width GL.

The drive electrode lines 61 and the drive pattern groups 63 forming a drive wiring group extend, being parallel to each other, from the respective starting point pattern elements 31RPs. Thus, the distance between two drive electrode lines 61, or the distance between the drive electrode line 61 and the drive pattern group 63 are maintained to be the wire space width GL.

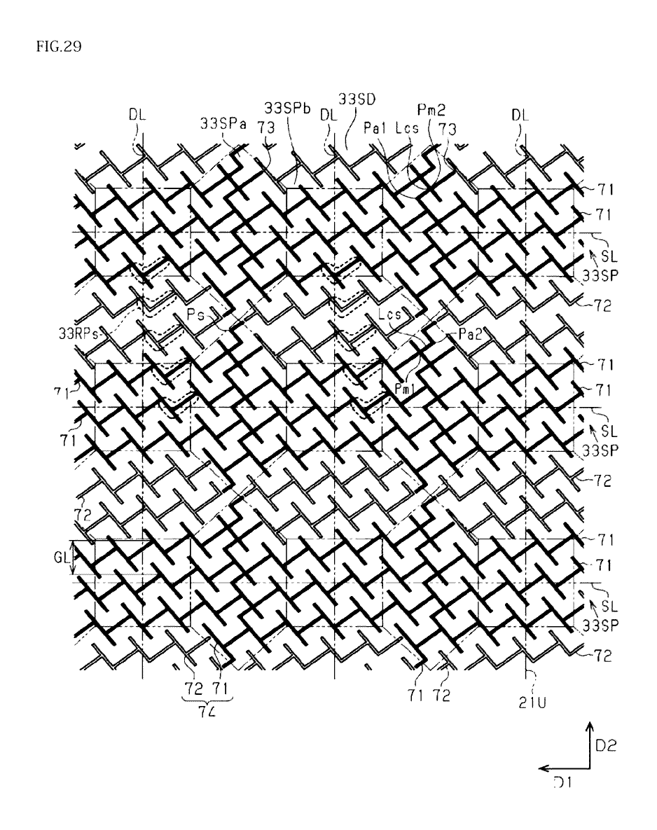

As shown in FIG. 29, the sensing electrode 33SP includes a plurality of sensing detection units 33SPa arrayed along the first direction D1, and sensing connection units 33SPb each connecting between two sensing detection units 33SPa adjacent to each other. The plurality of sensing electrodes 33SP are arranged along the second direction D2.

The sensing detection units 33SPa and the sensing connection units 33SPb in A sensing electrode 33SP are each formed of a plurality of sensing electrode lines 71. In other words, each sensing electrode 33SP is an assembly of the sensing electrode lines 71. Each sensing electrode line 71 includes, for example, a plurality of reference pattern elements 33RP whose reference direction is the second direction D2.

A sensing detection unit 33SPa includes, for example, five sensing electrode lines 71 arrayed at equal intervals along the second direction D2, with each sensing electrode line 71 extending along the first direction D1. The sensing connection unit 33SPb includes, for example, three sensing electrode lines 71 arrayed at equal intervals along the second direction D2, with each sensing electrode line 71 extending along the first direction D1.

Of the five sensing electrode lines 71 forming a sensing detection unit 33SPa, three sensing electrode lines 71 provided in series in the second direction D2 are respectively connected to the three sensing electrode lines 71 forming the sensing connection unit 33SPb.

The five sensing electrode lines 71 arrayed along the second direction D2 in the sensing detection unit 33SPa are each connected to the adjacently located sensing electrode line 71 via the sensing connection line Lcs extending in a direction perpendicular to the main line direction.

Some sensing connection lines Lcs each extend, for example, from the second main endpoint Pm2 of a reference pattern element 33RP of one sensing electrode line 71 towards the first auxiliary endpoint Pa1 of a reference pattern element 33RP of the sensing electrode line 71 adjacent in the second direction D2.

The rest of the sensing connection lines Lcs each extend, for example, from the second auxiliary endpoint Pa2 of a reference pattern element 33R of one sensing electrode line 71 towards the first main endpoint Pm1 of a reference pattern element 33RP of the sensing electrode line 71 adjacent in the second direction D2.

In a sensing detection unit 33Spa, four sensing connection lines Lcs form a sensing connection line group. The sensing connection line groups formed in the respective sensing detection units 33Spa are successively provided along the first direction D1.

A sensing dummy part 335D is located between two sensing electrodes 33SP adjacent in the second direction D2. The sensing dummy part 33SD is located between two successive sensing detection units 33SPa of one sensing electrodes 33SP and two successive sensing detection units 33SPa of the other sensing electrode 33SP.

The sensing dummy part 33SD is formed of, for example, two sensing dummy lines 72 arranged at equal intervals in the second direction D2, with each sensing dummy line 72 extending along the first direction D1. Each sensing dummy line 72 includes a plurality of reference pattern elements 33RP whose reference direction is the second direction D2.

In the first direction D1, the sensing dummy lines 72 forming the sensing dummy part 33SD are sandwiched by two sensing electrode lines 71. A sensing space 73 is provided between an end of a sensing electrode line 71 and an end of a sensing dummy line 72 adjacent in the first direction D1. One sensing dummy line 72 is separated from the sensing electrode line 71 by two sensing spaces 73 successively provided in the second direction. Thus, the sensing dummy part 33SD is separated from the sensing electrode 33SP.

In the sensing surface 33S, two sensing electrode lines 71 arrayed along the second direction D2 and three sensing pattern groups 74 are assigned to each unit area 21U. The three sensing pattern groups 74 each include a part of a sensing electrode line 71 arranged along the first direction D1 and a part of a sensing dummy line 72. In each unit area 21U, the sensing electrode lines 71 located at respective ends in the second direction D2 sandwich the three sensing pattern groups 74. The two sensing electrode lines 71 and the three sensing pattern groups 74 are arranged at equal intervals in the second direction D2. The space between two sensing electrode lines 71, or the space between a sensing electrode line 71 and a sensing pattern group 74 is the wire space width GL.

The two sensing electrode lines 71 and the three sensing pattern groups 74 form a sensing wiring group in each unit area 21U. The sensing wiring groups formed in the respective unit area 21U are disposed continuously in the first direction D1.

In a unit area 21U, similarly to the unit area 21U on the drive surface 31S, the reference pattern element 33RP located at an end in the first direction D1, among the plurality of reference pattern elements 33RP included in each wiring, is a starting point pattern element 33RPs. A plurality of reference pattern elements 33RP serially connected to a starting point pattern element 33RPs extend towards a starting point pattern element 33RPs whose position in the second direction D2 differs, from the first starting point pattern element 33RPs, by a multiple of 1 of the wire space width GL. Each starting point pattern element 33RPs in a unit area 21U of the sensing surface 33S is an example of the second starting point pattern element.

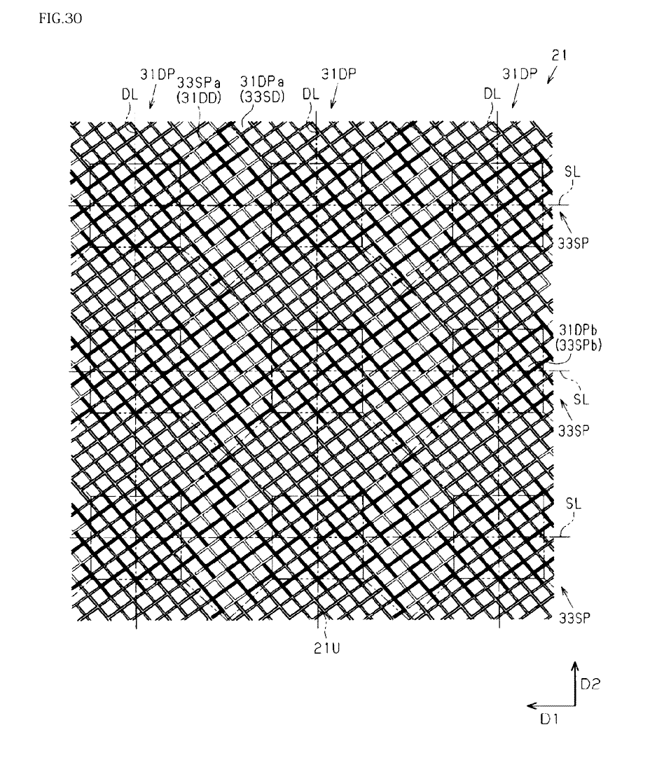

As shown in FIG. 30, in the touch sensor electrode 21, the drive detection unit 31DPa in plan view perpendicular to the sensing surface 33S overlaps with the sensing dummy part 33SD, the sensing detection unit 33SPa overlaps with the drive dummy part 31DD, and the drive connection unit 31DPb overlaps with the sensing connection unit 33SPb. This forms a lattice pattern in which the lattice units each having a square shape are continuously provided.

In each of the unit areas 21U of the drive surface 31S, a plurality of reference pattern elements 31RP serially connected to a starting point pattern element 31RPs extend towards a starting point pattern element 31RPs whose position in the first direction D1 differs, from the first starting point pattern element 31RPs, by a multiple of 1 of the wire space width GL. Further, in each of the unit areas 21U of the sensing surface 33S, a plurality of reference pattern elements 33RP serially connected to a starting point pattern element 33RPs extend towards a starting point pattern element 33RPs whose position in the second direction D2 differs, from the first starting point pattern element 33RPs, by a multiple of 1 of the wire space width GL.

The wire space width GL which determines the position of each starting point pattern element 31RPs on the drive surface 31S also serves as a parameter for determining an angle formed between a direction in which the main line Lm extends and the first direction D1. The wire space width GL for determining the position of each starting point pattern element 31RPs on the sensing surface 33S also serves as a parameter for determining an angle formed between a direction in which the main line Lm extends and the second direction D2. Thus, the wire space width GL is determined so that an angle formed between a direction in which the main line Lm extends and a reference direction thereof is in a range of not less than 58° to not more than 68°.

The touch sensor electrode 21 having such a configuration is formed with the following design. That is, in the wirings forming a drive wiring group, positions of the starting point pattern elements 31RPs in the first direction D1 are determined in one unit area 21U. Further, the direction of extending a plurality of reference pattern elements 31RP serially connected to each starting point pattern element 31RPs is determined to a direction towards another starting point pattern element 31RPs which is offset n-times (n is an integer 1 or more) the wire space width GL in the first direction D1. The feature n-times in such conditions is set so that the angle formed between the direction in which the main line Lm extends and the reference direction thereof is in a range of not less than 58° to not more than 68°.

Further, in the wirings forming the sensing wiring group, the positions in the second direction D2 of the starting point pattern elements 33RPs are determined in one unit area 21U. Further, the direction of extending a plurality of reference pattern elements 33RP serially connected to each starting point pattern element 33RPs in a unit area 21U is set to a direction towards another starting point pattern element 33RPs which is offset n-times (n is an integer 1 or more) the wire space width GL in the second direction D2. The feature n-times in such conditions is set so that the angle formed between the direction in which the main line Lm extends and the reference direction thereof is in a range of not less than 58° to not more than 68°.

The plurality of drive wiring groups continuing in the second direction D2 are connected to the plurality of sensing wiring groups continuing in the first direction D1 so as to form a lattice pattern in plan view perpendicular to the sensing surface 33S.

With this configuration, it is not necessary to greatly change the design of the drive electrode 31DP and the drive dummy part 31DD on the drive surface 31S, and the design of the sensing electrode 33SP and the sensing dummy part 33SD on the sensing surface 33S when changing the angle formed between the direction in which the main line Lm extends and the reference direction thereof.

In the fifth modification, in a unit area 21U of the drive surface 31S, the plurality of reference pattern elements 31RP serially connected to the starting point pattern element 31RPs of the C wiring 31C may extend towards the starting point pattern element 31RPs of the A wiring 31A in the adjacently located unit area 21U in the first direction D1. Alternatively, the plurality of reference pattern elements 31RP serially connected to the starting point pattern element 31RPs of the D wiring 31D may extend towards the starting point pattern element 31RPs of the A wiring 31A in the adjacently located unit area 21U in the first direction D1.

Basically, a plurality of reference pattern elements 31RP serially connected to a starting point pattern element 31RPs only need to be arrayed so as to extend towards a starting point pattern element whose position in the second direction D2 is offset by an integer multiple of the wire space width GL. In a unit area 21U of the sensing surface 33S, the direction of extending a plurality of reference pattern elements serially connected to a starting point pattern element 33RPs of each wiring 33RP only needs to be determined conforming to the unit area 21U of the drive surface 31S.

The fifth modification and the equivalent configurations thereof can be implemented in combination with the configurations of the first embodiment, the first modification, the second modification, the third modification, or the fourth modification.

In one aspect, the present invention can provide a touch sensor electrode which can prevent the generation of Moiré, a touch panel and a display device.

An aspect of a touch sensor electrode includes a plurality of first electrodes arrayed along a first direction, each of the plurality of first electrodes extending along a second direction perpendicular to the first direction; a plurality of second electrodes arrayed along a second direction, each of the plurality of second electrodes extending along the first direction; and a transparent dielectric substrate sandwiched between a first surface on which the plurality of first electrodes are arrayed and a second surface on which the plurality of second electrodes are arrayed. The first electrode and the second electrode include a plurality of reference pattern elements having respective patterns in which a reference direction, as a reference, is separately determined for the first electrode and for the second electrode. The reference pattern element includes a main line and a sub-line; the main line extends linearly from a first main endpoint to a second main endpoint in a main line direction that is a direction for forming an angle in a range of not less than 58° to not more than 68° relative to the reference direction; and the sub-line extends linearly from the second main endpoint to a sub-endpoint in a direction perpendicular to the main line and has a half the length of the main line, the sub-endpoint being the first main endpoint of another reference pattern element located in the main line direction with relative to the sub-line. The reference direction in the first electrode is the first direction; the reference direction in the second electrode is the second direction; and a combination of the plurality of first electrodes and the plurality of second electrode forms a lattice pattern including the plurality of reference pattern elements in plan view perpendicular to the transparent dielectric substrate, the lattice pattern including lattice units each being in a square shape having the same length as the sub-line on a side.

An aspect of a touch panel includes the touch sensor electrode, a cover layer that covers the touch sensor electrode, and a peripheral circuit that measures an electrostatic capacitance between the first electrode and the second electrode.

An aspect of a display device includes a display panel that has a plurality of pixels arrayed in a matrix pattern along the first direction and the second direction, and uses the pixels to display information; the touch panel according to claim 12; and a drive circuit that drives the touch panel. The touch panel is configured to pass therethrough the information to be displayed by the display panel.

A display device including a touch panel is typically provided with a plurality of pixels arrayed in a matrix pattern along a first direction in which first electrodes are arrayed and a second direction in which second electrodes are arrayed. With this configuration, squares formed by the first electrodes and the second electrodes have an inclination in the range of not less than 58° to not more than 68° relative to the directions in which the plurality of pixels are arrayed. Therefore, Moiré is prevented from being generated in the display device, which is caused by the array of a plurality of electrodes in the touch sensor electrode and the array of the plurality of pixels.

In another aspect of the touch sensor electrode, the reference pattern element may include two auxiliary lines. For example, each of the two auxiliary lines linearly extends in an extension direction of the sub-line and has the same length as the sub-line. One of the two auxiliary lines can extend from the second main endpoint, and the other of the two auxiliary lines can extend from the sub-endpoint.

In a further aspect, each of the two auxiliary lines linearly may extend in the main line direction and may have the same length as the sub-line. Further, one of the two auxiliary lines can extend from the first main endpoint, and the other of the two auxiliary lines can extend from the second main endpoint.

With this configuration, since two auxiliary lines are further added to a reference pattern element, the region where the reference pattern element is repeated is increased in a lattice pattern, compared to a reference pattern element which does not include such auxiliary lines. As a result, the region configured by the repetitions of the reference pattern element is increased in the lattice pattern, and thus the load involved in designing the lattice pattern is mitigated.

In another aspect of the touch sensor electrode, each first electrode includes a plurality of first electrode lines arrayed along the first direction, and each of the plurality of first electrode lines includes the plurality of reference pattern elements arrayed along a direction perpendicular to the first direction. Each second electrode includes a plurality of second electrode lines arrayed along the second direction, and each of the plurality of second electrode lines includes the plurality of reference pattern elements arrayed along a direction perpendicular to the second direction. In plan view, it is preferable that the first electrode intersects with each of the second electrodes, and the first electrode further includes at least one first connection line connecting between the first electrode lines adjacent in the first direction, in each portion intersecting the second electrode. Further, it is preferable that the second electrode further includes at least one second connection line connecting between the second electrode lines adjacent in the second direction, in each portion intersecting the first electrode.

With this configuration, if a first electrode line connected to another first electrode line is cut midway in the second direction, a part of the cut first electrode line can function as a first electrode through the other first electrode line. Further, if a second electrode line connected to another second electrode line is cut midway in the first direction, a part of the cut second electrode line can function as a second electrode through the other second electrode line. Therefore, the touch sensor electrode has a high durability to the cutting of the electrode lines in a first electrode or a second electrode.

Another aspect of the touch sensor electrode further includes a first dummy part located between the first electrodes adjacent to each other on the first surface and electrically insulated from the first electrodes. Each first electrode may include a plurality of first wide parts arrayed along the second direction, and first narrow parts each connecting between two first wide parts adjacent in the second direction, each first wide part including the plurality of reference pattern elements, each first narrow part including the plurality of reference pattern elements. It is preferable that the first dummy part has a portion facing the second electrode, and forms a part of the lattice pattern in plan view.

In the foregoing aspect, it is preferable that a part of the first dummy part and a part of the reference pattern element form different sides of one lattice unit.

When viewed from spaces between the first electrodes in plan view perpendicular to the transparent dielectric substrate, there is a concern that the second electrodes formed on a surface different from that of the first electrodes are visually recognized as a structure different from the first electrodes. In this regard, according to the foregoing aspects, the first dummy part facing the second electrode is located in a space between the first electrodes in plan view perpendicular to the transparent dielectric substrate, and a lattice pattern is also formed with the first dummy part. Therefore, the concern that the first electrodes are recognized as a structure different from that of the second electrodes can be reduced.

Another aspect of the touch sensor electrode further includes a first dummy part located between the first electrodes adjacent to each other on the first surface and electrically insulated from the first electrodes; and a second dummy part located between the second electrodes adjacent to each other on the second surface and electrically insulated from the second electrodes. Each first electrode may include a plurality of first wide parts arrayed along the second direction, and first narrow parts each connecting between two first wide parts adjacent in the second direction, each first wide part including the plurality of reference pattern elements, each first narrow part including the plurality of reference pattern elements. Each second electrode may include a plurality of second wide parts arrayed along the first direction, and second narrow parts each connecting between two second wide parts adjacent in the first direction, each second wide part including the plurality of reference pattern elements, each second narrow part including the plurality of reference pattern elements. It is preferable that the first wide part is located between the second electrodes adjacent in the second direction, and located between two second wide parts adjacent in the first direction, and the second wide part is located between the first electrodes adjacent in the first direction, and located between two first wide parts adjacent in the second direction. It is preferable that, in plan view, the first dummy part and the second dummy part form a part of the lattice pattern, the first narrow part faces the second narrow part, the first wide part faces the second dummy part, and the second wide part faces the first dummy part.

In the foregoing aspect, it is preferable that a part of the first dummy part and a part of the reference pattern element form different sides of one lattice unit, and a part of the second dummy part and a part of the reference pattern element form different sides of one lattice unit.

According to the foregoing aspect, the first wide part is unlikely to overlap with the second wide part in plan view, and a change in electrostatic capacitance between the first wide part and the second wide part is measured by the peripheral circuit included in the touch sensor. Therefore, compared with the configuration of measuring a change in electrostatic capacitance between the mutually overlapped first and second wide parts in plan view by means of a peripheral circuit, when a conductor such as a person's finger, for example, approaches between the first and second wide parts, the electrostatic capacitance formed between the first and second wide parts changes greatly. Therefore, the sensitivity for detecting a contact position of a person's finger increases in the touch sensor provided with the touch sensor electrode.

In another aspect of the touch sensor electrode, in plan view, a group including the first electrode and the first dummy part may have the same hue as that of the second electrode, with at least one of brightness and saturation being different from that of the second electrode.

In another aspect of the touch sensor electrode, in plan view, the group including the first electrode and the first dummy part may have color attributes different from those of the second electrode.

In another aspect of the touch sensor electrode, a straight line passing through each of the first electrodes in the center of the first direction is a first straight line; a straight line passing through the center of each of the second electrodes in the second direction is a second straight line; and an area in a square shape defined by two first straight lines adjacent to each other and two second straight lines adjacent to each other is a unit area. In the unit area, the reference pattern element located at an end, in the first direction, of the plurality of reference pattern elements included in each first electrode is a first starting point pattern element, and the reference pattern element located at an end, in the second direction, of the plurality of reference pattern elements included in each second electrode is a second starting point pattern element. A plurality of the first starting point pattern elements may be successively provided along the first direction on a unit-area basis; and a plurality of the second starting point pattern elements may be successively provided along the second direction on a unit-area basis. It is preferable that a plurality of the reference pattern elements serially connected to one first starting point pattern element extend towards another first starting point pattern element in the unit area adjacently located in the second direction; and a plurality of the reference pattern elements serially connected to one second starting point pattern element extend towards another second starting point pattern element in the unit area adjacently located in the first direction.

According to the foregoing aspect of the touch sensor electrode, when the inclination of the plurality of line segments that form a lattice pattern is changed relative to the first direction and the second direction, the positions of the first electrode lines and the second electrode lines can be determined as the electrode lines including the reference pattern elements. Therefore, the load for designing the first electrode lines and the second electrode lines can be mitigated.

According to an aspect of the present invention, generation of Moiré can be prevented.

### REFERENCE SIGNS LIST

10 . . . display panel, 10S . . . display surface, 11 . . . lower polarizer, 12 . . . thin film transistor substrate, 13 . . . TFT layer, 14 . . . liquid crystal layer, 15 . . . color filter layer, 15a . . . black matrix, 15B . . . blue color layer, 15G . . . green color layer, 15P . . . pixel, 15R . . . red color layer, 16 . . . color filter substrate, 17 . . . upper polarizer, 20 . . . touch panel, 20S . . . control surface, 21 . . . touch sensor electrode, 21C . . . cell, 22 . . . cover layer, 23 . . . transparent adhesive layer, 31 . . . transparent substrate, 31DP, 31DP1, 31DPn . . . drive electrode, 31DPa . . . drive detection unit, 31DPb . . . drive connection unit, 31DPc . . . drive spaces, 31L . . . drive electrode lines, 31RP, 33RP . . . reference pattern element, 31S . . . drive surface, 32 . . . transparent adhesive layer, 33 . . . transparent dielectric substrate, 33L . . . sensing electrode lines, 33S . . . sensing surface, 33SP, 33SP1, 33SPn . . . sensing electrode, 33SPa . . . sensing detection unit, 33SPb . . . sensing connection unit, 33SPc . . . sensing spaces, 34 . . . selection circuit, 35 . . . detection circuit, 35a . . . signal acquiring unit, 35b . . . signal processing unit, 36 . . . control unit, La . . . auxiliary lines, Lm . . . main line, Ls . . . sub-line, Lcd, Lcd1, Lcd2 . . . drive connection line, Lcs . . . sensing connection line, Ls1 . . . intersection sub-line, Pa1 . . . first auxiliary endpoint, Pa2 . . . second auxiliary endpoint, Pm1 . . . first main endpoint, Pm2 . . . second main endpoint, Pm3 . . . center point, Ps . . . sub-endpoint, SD . . . drive electrode line area, SS . . . sensing electrode line area.
   Obviously, numerous modifications and variations of the present invention are possible in light of the above teachings. It is therefore to be understood that within the scope of the appended claims, the invention may be practiced otherwise than as specifically described herein.

What is claimed is:

1. A touch sensor electrode, comprising:
a transparent dielectric substrate having a first surface and a second surface opposite to the first surface,
a plurality of first electrodes arrayed in a first direction on the first surface and each extending along a second direction perpendicular to the first direction; and
a plurality of second electrodes arrayed in the second direction on the second surface and each extending along the first direction,
wherein each one of the first electrodes and each one of the second electrodes include a plurality of reference pattern elements,
each of the reference pattern elements has a main line and a sub-line and forms a pattern with reference to a reference direction, which is the first direction for the first electrodes and the second direction for the second electrodes, respectively,
the main line extends linearly from a first main endpoint to a second main endpoint in a main line direction that forms an angle in a range of from 58° to 68° relative to the reference direction,
the sub-line extends linearly from the second main endpoint to a sub-endpoint in a direction perpendicular to the main line and has a length half of the main line, where the sub-endpoint is the first main endpoint of another reference pattern element located in the main line direction with relative to the sub-line, and
the first and second electrodes are formed such that the reference pattern elements of the first and second electrodes together form a lattice pattern in plan view perpendicular to the transparent dielectric substrate, and that the lattice pattern include a plurality of lattice units each in a square shape where each side has a same length as the sub-line.

2. The touch sensor electrode of claim 1, wherein each of the reference pattern elements includes two auxiliary lines each of which extends linearly along the sub-line and has the same length as the sub-line, and
the two auxiliary lines include one extending from the second in main endpoint and the other extending from the sub-endpoint.

3. The touch sensor electrode of claim 1, wherein each of the reference pattern elements includes two auxiliary lines each of which linearly extends in the main line direction and has the same length as the sub-line, and
the two auxiliary lines include one extending from the first main endpoint and the other extending from the second main endpoint.

4. The touch sensor electrode of claim 1, wherein each of the first electrodes includes first electrode lines which are arrayed in the first direction and each include the reference pattern elements arrayed in a direction perpendicular to the first direction,
each of the second electrodes includes second electrode lines which are positioned along the second direction and each include the reference pattern elements arrayed in a direction perpendicular to the second direction, and
the first and second electrodes are formed such that, in the plan view, the first electrodes intersect with the second electrodes, each of the first electrodes further includes at least one first connection line connecting between the first electrode lines adjacent in the first direction, in each portion intersecting one of the second electrodes, and each of the second electrodes further includes at least one second connection line connecting between the second electrode lines adjacent in the second direction, in each portion intersecting one of the first electrodes.

5. The touch sensor electrode of claim 1, further comprising:
a first dummy part located between first electrodes adjacent to each other on the first surface and electrically insulated from the first electrodes,
wherein each of the first electrodes includes a plurality of first wider portions and a plurality of first narrower portions narrower than the first wider portions such that the first wider portions are arrayed in the second direction, and that the first narrower portions each connect between two first wider portions adjacent in the second direction,
each of the first wider portions and each of the first narrower portions include the reference pattern elements, and
the first dummy part has a portion facing one of the second electrodes and forms a part of the lattice pattern in the plan view.

6. The touch sensor electrode of claim 5, wherein the first dummy part and the reference pattern elements are formed such that a portion of the first dummy part and a portion of one of the reference pattern elements form different sides of one lattice unit.

7. The touch sensor electrode of claim 1, further comprising:
a first dummy part located between first electrodes adjacent to each other on the first surface and electrically insulated from the first electrodes, and
a second dummy part located between second electrodes adjacent to each other on the second surface and electrically insulated from the second electrodes,
wherein each of the first electrodes includes a plurality of first wider portions and a plurality of narrower portions narrower than the first wider portions such that the first wider portions are arrayed in the second direction, and that the first narrower portions each connect between two first wider portions adjacent in the second direction,
each of the first wider portions and each of the first narrower portions include the reference pattern elements,
each of the second electrodes includes a plurality of second wider portions and a plurality of second narrower portions narrower than the second wider portions such that the second wider portions are arrayed in the first direction, and that the second narrower portions each connect between two second wider portions adjacent in the first direction,
each of the second wider portions and each of the second narrower portions include the reference pattern elements,
one of the first wider portions is located between the second electrodes adjacent in the second direction, and located between two second wider portions adjacent in the first direction,
one of the second wider portions is located between the first electrodes adjacent in the first direction, and located between two first wider portions adjacent in the second direction, and
the first and second dummy parts are formed such that, in the plan view, the first and second dummy parts form a part of the lattice pattern, one of the first narrower portions faces one of the second narrower portions, one of the first wider portions faces the second dummy part, and one of the second wider portions faces the first dummy part.

8. The touch sensor electrode of claim 7, wherein the first and second dummy parts and the reference pattern elements are formed such that a portion of the first dummy part and a portion of one of the reference pattern elements form different sides of one lattice unit, and that a portion of the second dummy part and a portion of one of the reference pattern elements form different sides of one lattice unit.

9. The touch sensor electrode of claim 5, wherein, in the plan view, a group including one of the first electrodes and the first dummy part has a hue which is same as a hue of one of the second electrodes, and the group is different from the second electrode in at least one of brightness and saturation.

10. The touch sensor electrode of claim 5, wherein, in the plan view, the group including one of the first electrodes and the first dummy part has a color attribute different from a color attribute of one of the second electrodes.

11. The touch sensor electrode of claim 1, wherein the first and second electrodes are formed such that, in the plan view, two adjacent first electrodes and two adjacent second electrodes form a unit area in a square form defined by a center line of each of the two adjacent first electrodes and the two adjacent second electrodes,
the unit area includes a plurality of first starting point pattern elements and a plurality of second starting point pattern elements, where each of the first starting point pattern elements is the reference pattern element located at an end, in the first direction, of the reference pattern elements included in each of the first electrodes, and each of the second starting point pattern elements is the reference pattern element located at an end, in the second direction, of the reference pattern elements included in each of the second electrodes,
the first starting point pattern elements are successively positioned along the first direction in the unit area,
the second starting point pattern elements are successively positioned along the second direction in the unit area,
the reference pattern elements connected to one of the first starting point pattern elements extend towards another of the first starting point pattern elements in the unit area adjacently located in the second direction, and
the reference pattern elements connected to one of the second starting point pattern elements extend towards another of the second starting point pattern elements in the unit area adjacently located in the first direction.

12. The touch sensor electrode of claim 1, further comprising:
a transparent adhesive layer with which the first electrodes are bonded to the first surface.

13. The touch sensor electrode of claim 1, further comprising:
a transparent substrate positioned between the transparent dielectric substrate and the first electrodes.

14. A touch panel, comprising:
the touch sensor electrode of claim 1;
a cover layer that covers the touch sensor electrode; and
a peripheral circuit configured to measure an electrostatic capacitance between the first electrodes and the second electrodes.

15. A display device, comprising:
a display panel configured to display information and including a plurality of pixels positioned in a matrix pattern along the first direction and the second direction;
the touch panel of claim 14; and
a drive circuit configured to drive the touch panel,
wherein the touch panel is configured such that the information to be displayed by the display panel passes through the touch panel.
